(19) United States
(12) Patent Application Publication
(10) Pub. No.: US 2025/0310800 A1
(43) Pub. Date: Oct. 2, 2025

(54) POWER ADAPTATION FOR COVERAGE ENHANCEMENT

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 19/081,942

(22) Filed: Mar. 17, 2025

Related U.S. Application Data
(60) Provisional application No. 63/572,045, filed on Mar. 29, 2024.
(60) Provisional application No. 63/632,898, filed on Apr. 11, 2024.
(60) Provisional application No. 63/635,200, filed on Apr. 17, 2024.
(60) Provisional application No. 63/638,674, filed on Apr. 25, 2024.
(60) Provisional application No. 63/642,318, filed on May 3, 2024.
(60) Provisional application No. 63/665,919, filed on Jun. 28, 2024.

(51) Int. Cl. H04W 24/04; H04B 17/318; H04W 74/0833

(52) U.S. Cl. CPC H04W 24/04; H04B 17/328; H04W 74/0833

(57) ABSTRACT

Apparatuses and methods for power adaptation for coverage enhancement. A method for a beam failure recovery (BFR) procedure on a first cell includes receiving information for a set of power values for a synchronization signal and primary broadcast channel (SS/PBCH) block on the first cell, for a set of reference signal received power (RSRP) threshold values associated with the SS/PBCH block on the first cell, for a mapping between the set of power values and the set of RSRP threshold values, and indicating a first power value. The method further includes receiving the SS/PBCH block on the first cell, determining an RSRP threshold value, determining an RSRP value based on the SS/PBCH block on the first cell, and determining to perform a beam failure recovery (BFR) procedure on the first cell when the RSRP value is smaller than the RSRP threshold value.

### CROSS-REFERENCE TO RELATED AND CLAIM OF PRIORITY

The present application claims priority under 35 U.S.C. § 119 (e) to U.S. Provisional Patent Application No. 63/572,045 filed on Mar. 29, 2024; U.S. Provisional Patent Application No. 63/632,898 filed on Apr. 11, 2024; U.S. Provisional Patent Application No. 63/635,200 filed on Apr. 17, 2024; U.S. Provisional Patent Application No. 63/638,674 filed on Apr. 25, 2024; U.S. Provisional Patent Application No. 63/642,318 filed on May 3, 2024; and U.S. Provisional Patent Application No. 63/665,919 filed on Jun. 28, 2024, which are hereby incorporated by reference in their entirety.

### TECHNICAL FIELD

The present disclosure relates generally to wireless communication systems and, more specifically, the present disclosure is related to apparatuses and methods for power adaptation for coverage enhancement.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to power adaptation for coverage enhancement.

In one embodiment, a method for a user-equipment (UE) to perform a beam failure recovery (BFR) procedure on a first cell is provided. The method includes receiving first information for a set of power values for a synchronization signal and primary broadcast channel (SS/PBCH) block on the first cell, receiving second information for a set of reference signal received power (RSRP) threshold values associated with the SS/PBCH block on the first cell, receiving third information for a mapping between the set of power values and the set of RSRP threshold values, receiving fourth information indicating a first power value from the set of power values, and receiving the SS/PBCH block on the first cell. The method further includes determining an RSRP threshold value, based on the third information and the first power value, determining an RSRP value based on the SS/PBCH block on the first cell, and determining to perform a beam failure recovery (BFR) procedure on the first cell when the RSRP value is smaller than the RSRP threshold value.

In another embodiment, a UE is provided. The UE includes a transceiver configured to receive first information for a set of power values for a SS/PBCH block on a first cell, receive second information for a set of RSRP threshold values associated with the SS/PBCH block on the first cell, receive third information for a mapping between the set of power values and the set of RSRP threshold values, receive fourth information indicating a first power value from the set of power values, and receive the SS/PBCH block on the first cell. The UE further includes a processor operably coupled to the transceiver. The processor configured to determine an RSRP threshold value, based on the third information and the first power value, determine an RSRP value based on the SS/PBCH block on the first cell, and determine to perform a BFR procedure on the first cell when the RSRP value is smaller than the RSRP threshold value.

In yet another embodiment, a base station is provided. The base station includes a processor and a transceiver operably coupled to the transceiver. The transceiver is configured to transmit first information for set of power values for a SS/PBCH block on a first cell, transmit second information for a set of RSRP threshold values associated with the SS/PBCH block on the first cell, transmit third information for a mapping between the set of power values and the set of RSRP threshold values, transmit fourth information indicating a first power value from the set of power values, and transmit the SS/PBCH block on the first cell.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure according to embodiments of the present disclosure;

FIG. 8 illustrates an example encoding structure for physical downlink control channel (PDCCH) in a subframe according to embodiments of the present disclosure;

FIG. 9 illustrates an example decoding structure for PDCCH in a subframe according to embodiments of the present disclosure;

FIG. 10 illustrates a diagram of an example non-terrestrial network (NTN) according to embodiments of the present disclosure;

FIG. 11 illustrates an example system for cell coverages according to embodiments of the present disclosure;

FIG. 12 illustrates a flowchart of an example UE procedure for cell selection according to embodiments of the present disclosure;

FIG. 13 illustrates a flowchart of an example UE procedure for cell selection according to embodiments of the present disclosure;

FIG. 14 illustrates example timelines for reception and reporting according to embodiments of the present disclosure;

FIG. 15 illustrates a flowchart of an example UE procedure for transitioning to a discontinuous reception (DRX) mode according to embodiments of the present disclosure;

FIG. 16 illustrates a flowchart of an example UE procedure for transitioning to a DRX mode according to embodiments of the present disclosure;

FIG. 17 illustrates a flowchart of an example UE procedure for transmitting sounding reference signal (SRS) according to embodiments of the present disclosure;

FIG. 18 illustrates a flowchart of an example UE procedure for reporting measurements according to embodiments of the present disclosure;

FIG. 19 illustrates a flowchart of an example UE procedure for transitioning to a low power consumption state and performing reference signal received power (RSRP) measurements according to embodiments of the present disclosure;

FIG. 20 illustrates a diagram of an example NTN according to embodiments of the present disclosure;

FIG. 21 illustrates a diagram of an example NTN according to embodiments of the present disclosure;

FIG. 22 illustrates a flowchart of an example procedure for beam failure recovery (BFR) according to embodiments of the present disclosure;

FIG. 23 illustrates a flowchart of an example procedure for BFR according to embodiments of the present disclosure;

FIG. 24 illustrates a flowchart of an example UE procedure for BFR according to embodiments of the present disclosure; and

FIG. 25 illustrates a flowchart of an example procedure for a beam change according to embodiments of the present disclosure.

### DETAILED DESCRIPTION

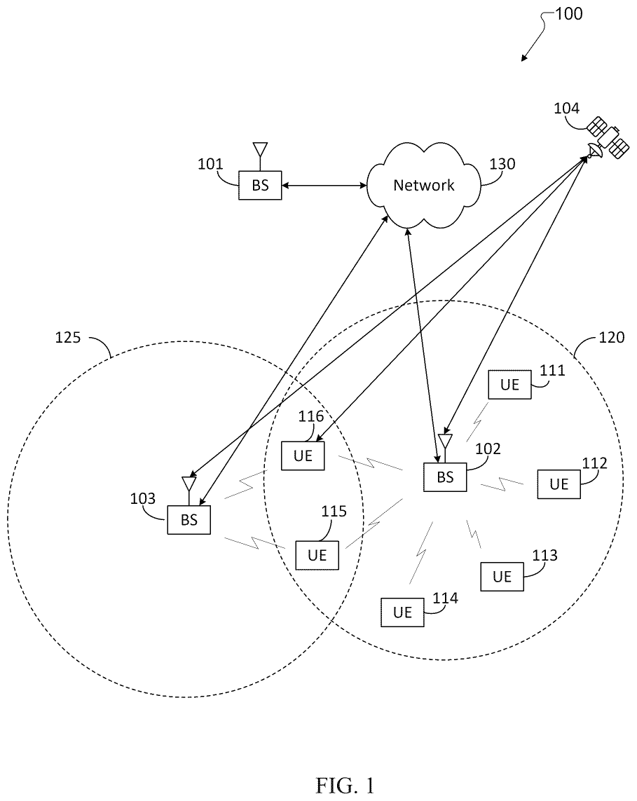

FIGS. 1-25, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.1.0, “NR; Physical channels and modulation;” [REF 2] 3GPP TS 38.212 v18.1.0, “NR; Multiplexing and channel coding;” [REF 3] 3GPP TS 38.213 v18.1.0, “NR; Physical layer procedures for control;” [REF 4] 3GPP TS 38.214 v18.1.0, “NR; Physical layer procedures for data;” [REF 5] 3GPP TS 38.321 v18.0.0, “NR; Medium Access Control (MAC) Protocol Specification;” and [REF 6] 3GPP TS 38.331 v18.0.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to common fronthaul and/or backhaul connections. The BSs can also be on board the communication satellite(s) 104. Various of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Taking into account the capabilities of providing wide coverage and reliable service, an NTN is envisioned to ensure service availability and continuity ubiquitously. For instance, an NTN can support communication services in unserved areas that cannot be covered by other terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for power adaptation for coverage enhancement. In certain embodiments, one or more of the BSs 101-103 include circuitry, programing, or a combination thereof to support power adaptation for coverage enhancement.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

Throughout this disclosure the terms satellite or serving gNB are used interchangeably to refer to any component (or collection of components) configured to provide remote terminals with wireless access to a network (e.g., the network 130). Descriptions directly apply to satellite network architectures with transparent payload and with non-transparent payload, and to any aerial platforms such as unmanned aerial service (UAS) platforms, as well as to terrestrial networks.

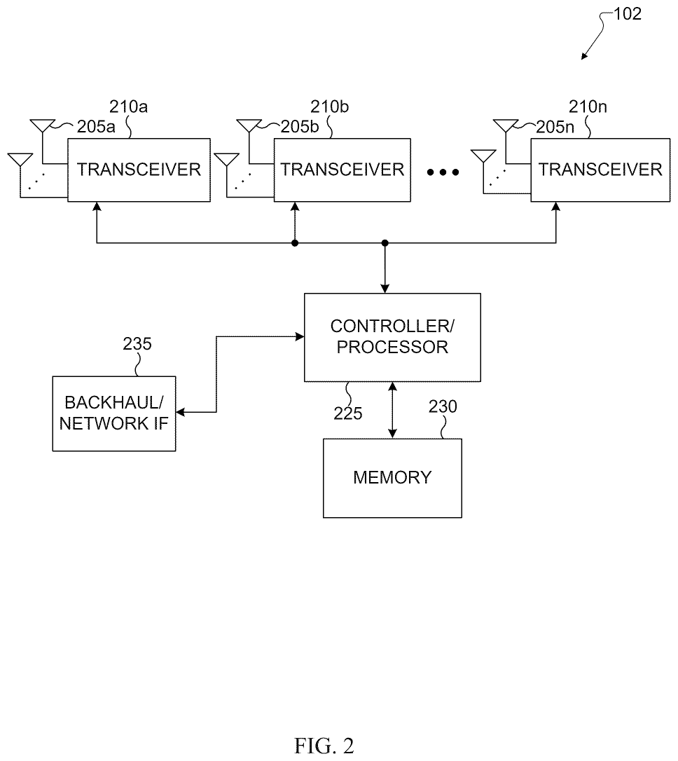

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for power adaptation for coverage enhancement. Any of a wide variety of other functions could be supported in the gNB 102 by the controller/processor 225.

The controller/processor 225 is also capable of executing programs and other processes resident in the memory 230, such as processes to trigger power adaptation for coverage enhancement. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

In certain embodiments, a plurality of instructions, such as a blind interference sensing (BIS) algorithm is stored in memory. The plurality of instructions are configured to cause the controller/processor 225 to perform the BIS process and to decode a received signal after subtracting out at least one interfering signal determined by the BIS algorithm.

As described in more detail below, the transmit and receive paths of the gNB 102 (e.g., implemented using the transceivers 210a-210n) support communication with aggregation of frequency division duplexing (FDD) cells and time division duplexing (TDD) cells.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

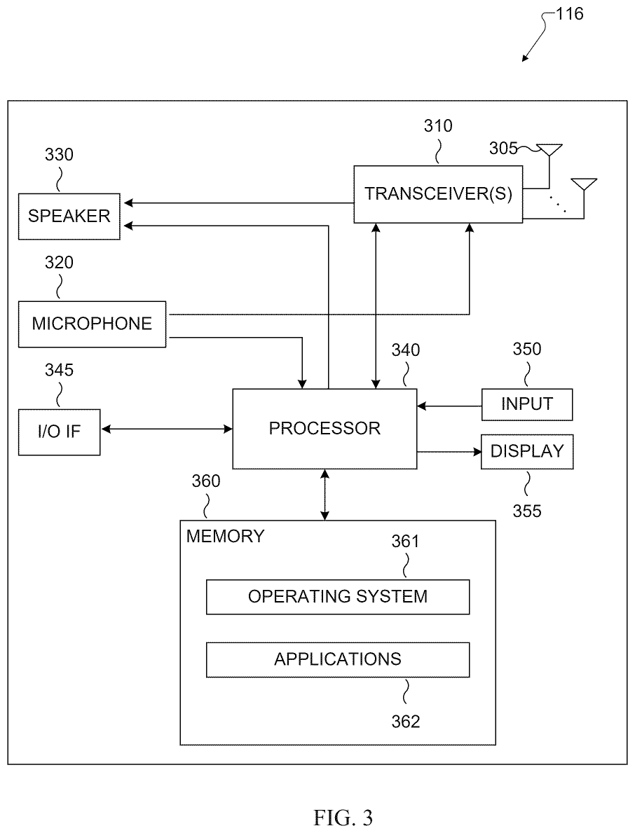

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for power adaptation for coverage enhancement as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

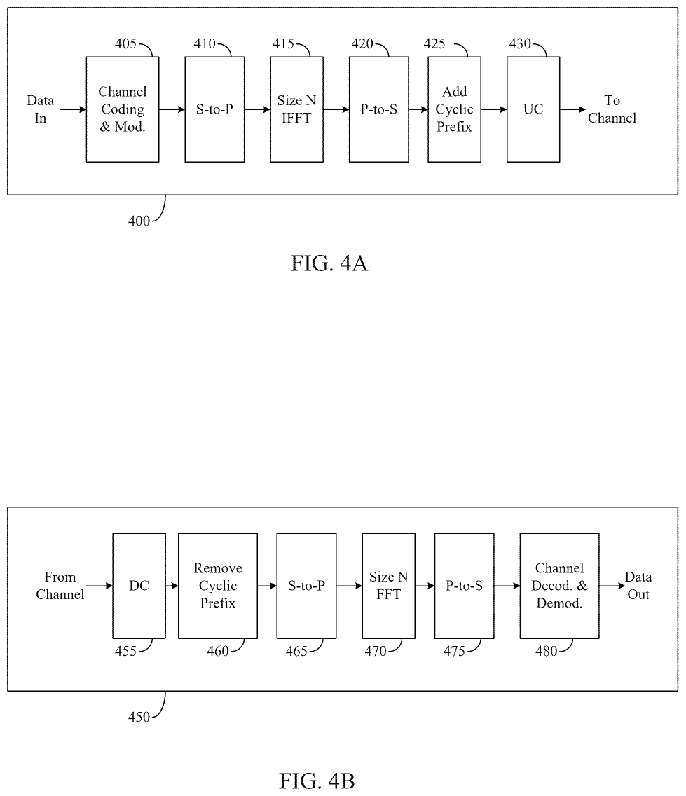

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for transmitting power adaptation for coverage enhancement as described in embodiments of the present disclosure. In some embodiments, the receive path 450 is configured for receiving power adaptation for coverage enhancement as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

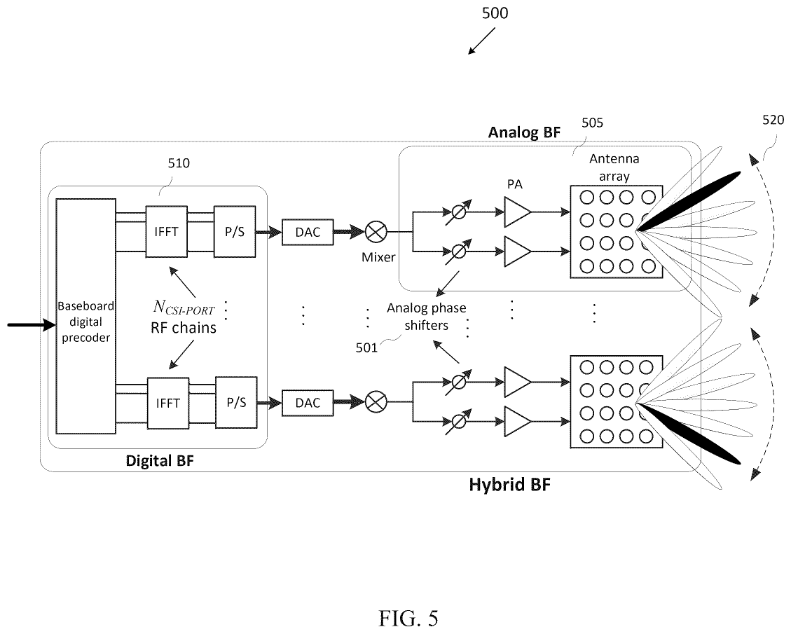

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mm Wave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In the following, an italicized name for a parameter implies that the parameter is provided by higher layers.

FIG. 6 illustrates an example of a transmitter structure 600 for PDSCH in a subframe according to embodiments of the present disclosure according to embodiments of the present disclosure. For example, transmitter structure 600 can be implemented in gNB 102 of FIG. 1. This example is for illustration only and other embodiments can be used without departing from the scope of the present disclosure.

Information bits, such as downlink control information (DCI) bits or data bits 610, are encoded by encoder 620, rate matched to assigned time/frequency resources by rate matcher 630, and modulated by modulator 640. Subsequently, modulated encoded symbols and demodulation reference signal (DM-RS) or CSI-RS 650 are mapped to REs 660 by RE mapping unit 665, an inverse fast Fourier transform (IFFT) is performed by filter 670, a cyclic prefix (CP) is added by CP insertion unit 680, and a resulting signal is filtered by filter 690 and transmitted by a radio frequency (RF) unit 695.

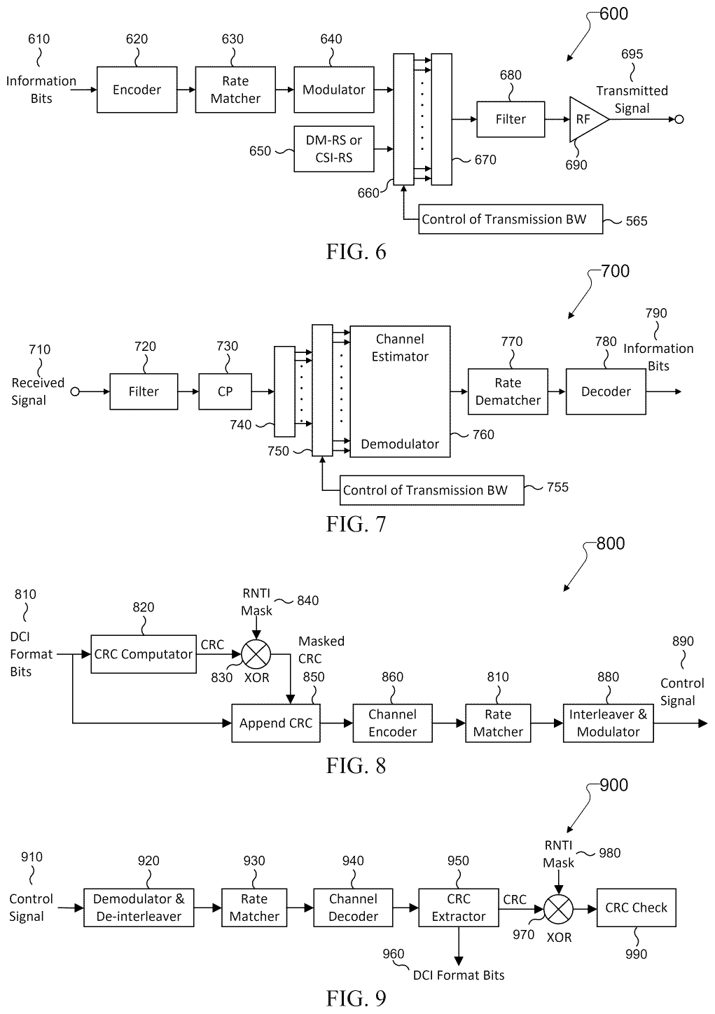

FIG. 7 illustrates an example of a receiver structure 700 for PDSCH in a subframe according to embodiments of the present disclosure according to embodiments of the present disclosure. For example, receiver structure 700 can be implemented by any of the UEs 111-116 of FIG. 1. This example is for illustration only and other embodiments can be used without departing from the scope of the present disclosure.

A received signal 710 is filtered by filter 720, a CP removal unit removes a CP 730, a filter 740 applies a fast Fourier transform (FFT), RE de-mapping unit 750 de-maps REs selected by bandwidth (BW) selector unit 755, received symbols are demodulated by a channel estimator and a demodulator unit 760, a rate de-matcher 770 restores a rate matching, and a decoder 780 decodes the resulting bits to provide information bits 790.

DL transmissions or UL transmissions can be based on an OFDM waveform including a variant using DFT precoding that is known as DFT-spread-OFDM that is typically applicable to UL transmissions.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 v18.1.0, “NR; Physical channels and modulation”, and [REF 3].

FIG. 8 illustrates an example encoding structure 800 for PDCCH in a subframe according to embodiments of the present disclosure. For example, encoding structure 800 for PDCCH in a subframe can be implemented in gNB 103 of FIG. 1. This example is for illustration only and other embodiments can be used without departing from the scope of the present disclosure.

A gNB (e.g., the gNB 102) separately encodes and transmits each DCI format in a respective PDCCH. When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 810 is determined using a CRC computation unit 820, and the CRC is masked using an exclusive OR (XOR) operation unit 830 between CRC bits and RNTI bits 840. The XOR operation is defined as XOR (0,0)=0, XOR (0,1)=1, XOR (1,0)=1, XOR (1,1)=0. The masked CRC bits are appended to DCI format information bits using a CRC append unit 850. An encoder 860 performs channel coding, such as polar coding, followed by rate matching to allocated resources by rate matcher 870. Interleaving and modulation units 880 apply interleaving and modulation, such as QPSK, and the output control signal 890 is transmitted.

FIG. 9 illustrates an example decoding structure 900 for PDCCH in a subframe according to embodiments of the present disclosure. For example, decoding structure 900 for PDCCH in a subframe can be implemented by any of the UEs 111-116 of FIG. 1. This example is for illustration only and other embodiments can be used without departing from the scope of the present disclosure.

A received control signal 910 is demodulated and de-interleaved by a demodulator and a de-interleaver 920. A rate matching applied at a gNB transmitter is restored by rate matcher 930, and resulting bits are decoded by decoder 940. After decoding, a CRC extractor 950 extracts CRC bits and provides DCI format information bits 960. The DCI format information bits are de-masked 970 by an XOR operation with a RNTI 980 (when applicable) and a CRC check is performed by unit 990. When the CRC check succeeds (check-sum is zero), the DCI format information bits are regarded to be valid. When the CRC check does not succeed, the DCI format information bits are regarded to be invalid.

DCI can serve several purposes. A DCI format includes information elements (IEs) and is typically used for scheduling a PDSCH (DL DCI format) or a physical uplink shared channel (PUSCH) (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with RRC connection to a gNB, the RNTI is a cell RNTI (C-RNTI) or another RNTI type such as a modulation and coding scheme-cell radio network temporary identifier (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access RNTI (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a transmit power control radio network temporary identifier (TPC-RNTI), and so on. Each RNTI type is configured to a UE through higher layer signaling. A UE typically decodes at multiple candidate locations for PDCCH transmissions.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates

$${M}_{s}^{( L )}$$

per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in v18.0.0 of [REF 2], or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number

$${n}_{s , f}^{μ}$$

in a frame with number n_{f} if

$$( {n}_{f} \cdot {N}_{slot}^{frame , μ} + {n}_{s , f}^{μ} - {o}_{s} ) mod {k}_{s} = 0 .$$

The UE monitors PDCCH candidates for search space set s for Ts consecutive slots, starting from slot

$${n}_{s , f}^{μ} ,$$

and does not monitor PDUCH candidates for search space set s for the next kₛ−Tₛ consecutive slots. The UE determines CCEs for monitoring PDCCH according to a search space set based on a search space equation as described in [REF 3].

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in [REF 3] and [REF 4].

In the following, unless otherwise explicitly noted, providing a parameter value by higher layers includes providing the parameter value by a system information block (SIB), such as a SIB1, or by a common RRC signaling, or by UE-specific RRC signaling.

The following descriptions and embodiments for a UE (e.g., the UE 116) performing measurements and corresponding measurement reporting equally apply when measurements and reporting by the UE are based on synchronization signal/physical broadcast channel (SS/PBCH) block receptions or CSI-RS receptions.

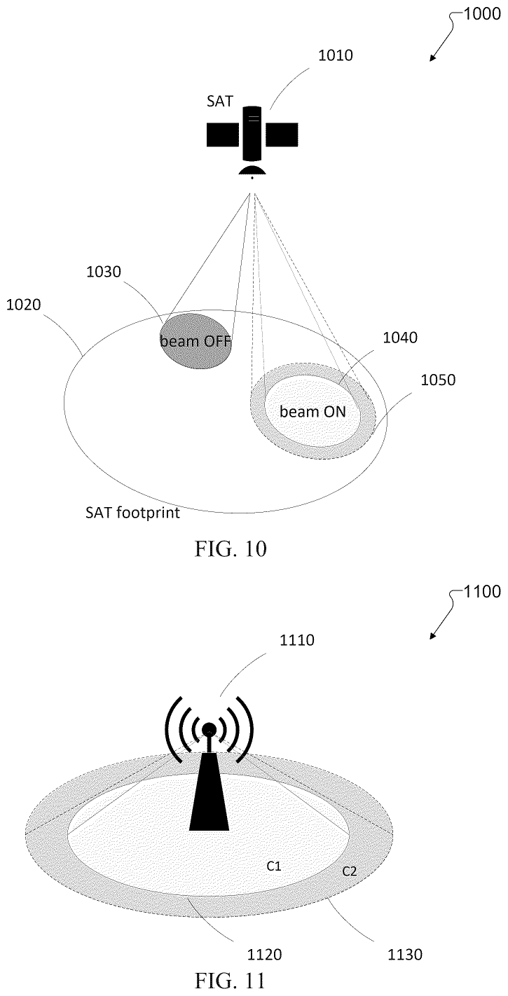

FIG. 10 illustrates a diagram of an example NTN 1000 according to embodiments of the present disclosure. For example, any of the UEs 111-116 of FIG. 1 can operate within the NTN 1000. This example is for illustration only and other embodiments can be used without departing from the scope of the present disclosure.

As shown in FIG. 10, the NTN 1000 includes a satellite 1010, a satellite footprint 1020, a beam 1030, a first beam width 1040, and a second beam width 1050.

With reference to FIG. 10, within the satellite footprint there can be a number of cells or spots, and each beam provided by a given non-terrestrial network (NTN)-payload can cover one cell or spot. The satellite 1010 uses a number of beams over the satellite footprint 1020 to serve users in corresponding number of cells for a given time period. For example, the satellite footprint can include a number N of cells or spots, and the satellite at any given time activates a number M of beams, with M<N, or activates all N beams. When the traffic over the satellite footprint is approximately equally distributed, or when there is a need to provide a same level of coverage in the satellite footprint, the satellite can use beams of approximately same beam width and transmit with approximately same power on each beam over the satellite footprint. When there is no traffic in a given area of the satellite footprint served by a beam, the satellite can switch off the beam 1030. The satellite can use a beam with a first beam width 1040, and over time, adapt the beam width to provide coverage over a larger area with a second beam width 1050.

FIG. 11 illustrates an example system 1100 for cell coverages according to embodiments of the present disclosure according to embodiments of the present disclosure. For example, system 1100 for cell coverage can serve any of the UEs 111-116 of FIG. 1. This example is for illustration only and other embodiments can be used without departing from the scope of the present disclosure.

As shown in FIG. 11, the system 1100 includes a serving gNB 1110, a cell C1 1120, and a cell C2 1130.

The following descriptions and embodiments directly apply or are adaptable to terrestrial networks (TN) and non-terrestrial networks (NTN), and functionalities of a satellite and/or of a satellite gateway on earth that is connected to the satellite in NTN can be same as the functionalities of a serving gNB in TN, or can be adapted taking also into account that the satellite footprint of a Low Earth Orbit (LEO) satellite moves over time because of the movement of the satellite respect to the earth. For a Geostationary Earth Orbiting (GEO) satellite, the satellite footprint is fixed, similar to a coverage area of a cell by the gNB in TN.

Throughout this disclosure the terms satellite or serving gNB (e.g., the BS 102) are used interchangeably to refer to any component (or collection of components) configured to provide remote terminals with wireless access to a network (e.g., the network 130). Descriptions directly apply to satellite network architectures with transparent payload and with non-transparent payload, and to any aerial platforms such as unmanned aerial service (UAS) platforms.

Throughout this disclosure the term beam hopping is generally used to indicate the operation of adapting beams over the satellite footprint in one or more of time/frequency/spatial/power domains, including switching on and off a beam, or using beams with different widths, or using different beams for different control or data channels over a same area or a partially overlapping area. A beam is defined based on a spatial relation for quasi co-location (QCL) properties of a source reference signal (RS) transmission, such as an SS/PBCH block (SSB) or a CSI-RS, or by a transmission configuration indicator (TCI) state that establishes a QCL relation or spatial relation between a source reference signal, such as an SSB and/or CSI-RS, and a target reference signal. The TCI state and/or the spatial relation reference RS can determine a spatial Rx filter for receptions by the UE, or a spatial Tx filter for transmissions from the UE. The TCI state and/or the spatial relation reference RS can determine a spatial Tx filter for transmissions from the gNB, or a spatial Rx filter for receptions by the gNB.

A NTN is a network using RF resources on board satellites or unmanned aerial service (UAS) platforms. The NTN includes satellites (e.g., the satellite 1010) that can be GEO satellites served by one or several satellite-gateways deployed across the satellites targeted coverage or LEO satellites served successively by one or several satellite-gateways at a time, a radio link between a satellite-gateway and the satellite or UAS platform, and a radio link between the UE and the satellite or UAS platform. A satellite or UAS platform may implement either a transparent payload, wherein the NTN payload transparently forwards the radio protocol received from the UE (via the service link) to the NTN Gateway (via the feeder link) and vice-versa, or a regenerative payload with onboard processing. An NTN gateway may serve multiple NTN payloads, and an NTN payload may be served by multiple NTN gateways. The satellite or UAS platform typically generates several beams over a service area or satellite footprint bounded by its field of view. The satellite footprint depends on the onboard antenna diagram and elevation angle. The footprint of a beam or a beam spot can have an elliptic shape and is evaluated for some aspects as a cell in terrestrial networks.

Beams over a satellite footprint can be generated by using multi-feed reflector antennas or phased-array antennas at the satellite. GEO satellites are usually equipped with multi-feed reflector antennas, while phased-array antennas are used for LEO satellites because of their wide-angle coverage capabilities. In order to suppress interference, different frequency bands and orthogonal polarizations may be used for the different beams, and reuse of the frequency bands would be among sufficiently isolated beams to guarantee sufficient system capacity. For LEO satellites, the coverage area and the propagation channel characteristics change due to the fast movement of the satellites, requiring a fast adaptation of resource allocation during connected and non-connected modes. Because of the large satellite footprint, traffic can be unequally distributed within the satellite footprint, including areas with high traffic and usually large areas with sparse or no traffic. In addition, limited payload power and feeder link bandwidth may limit the number of satellite beams that can be active simultaneously with a nominal equivalent isotropic radiated power (EIRP) density per beam at any given time. Such constraints demand solutions that minimize energy consumption and avoid or at least minimize interference between transmissions or receptions in different beams. Thus, it is necessary to flexibly control resources in the multiple beams of a satellite footprint in time, frequency, space or power domain to optimize performance while maintaining coverage.

Similar issues and need for solutions described herein for NTN directly apply to TN, wherein a serving gNB can operate with several beams for transmissions and receptions within a cell. The cell in a TN, differently than the NTN case or any aerial platform, does not move as the serving gNB is in a fixed position, however the traffic situation changes over time with some UEs requiring access and/or service and some other UEs transitioning from RRC_CONNECTED state to RRC_IDLE or RRC_INACTIVE state. Mobility of UEs or other types of terminals changes the traffic within the cell, and thus embodiments of the present disclosure further recognize that there is a need to adapt the network operation within the cell in order to provide the required services while optimizing network (e.g., the network 130) energy savings and UE power consumption. Therefore, it is necessary to flexibly control resources within the cell in time, frequency, space or power domain to optimize performance, minimize energy consumption for the network and the UEs while maintaining coverage.

One technique that can be used for controlling a transmission power of a satellite or of a network unit, transmissions and receptions for a time interval, antenna direction, or frequency band, is typically referred to as beam hopping. That technique generally indicates adaptation of a beam over a coverage area, including switching on and off beams over time over different areas or varying the transmit power of beams. Beam hopping can provide an efficient allocation of resources based on dynamic traffic needs within a satellite footprint.

For example, a satellite can use a beam width to transmit in a certain direction, and adapt a transmit power to provide coverage over a smaller area with a transmit power P1 or over a larger area with a transmit power P2 that is larger than P1.

For example, a satellite can adapt a beam width to provide coverage over a smaller or larger area, and correspondingly adapt also the transmit power by transmitting with a smaller transmit power when using the beam with the smaller beam width, and transmit with a larger transmit power when using the beam with the larger beam width.

For example, a satellite transmitting at a maximum power can adapt a beam width of a beam without changing the direction of the beam to provide coverage over a largest area within the satellite footprint, and/or can steer the beam in a different direction.

Similarly for a TN, with reference to FIG. 11, a serving gNB 1110 can provide coverage over a cell C1 1120 or over a cell C2 1130 by varying a transmit power. Based on the traffic needs, the serving gNB can adapt the transmit power while using a same beam (same beam width and same direction), or can adapt beam width and/or beam direction using a same transmission power, for example when the serving gNB is already transmitting at maximum power, or can adapt both beam width/direction and transmission power.

Present networks have limited capability for a serving gNB or satellite to dynamically, such as by L1 signaling or by a MAC CE, adapt a transmit power of a beam that provides coverage over a cell or over a satellite footprint, or a portion of the cell or satellite footprint. The serving gNB sets the transmit power to provide coverage over the cell, and usually maintains a same power even when the traffic conditions change. For a satellite that operates with multiple beams to cover the satellite footprint, the transmit power used in each beam is set to provide coverage for the corresponding area within the satellite footprint, and the same power is usually maintained while the beam is active; otherwise, the beam is de-activated. In other words, when a gNB uses a beam to transmit, the transmission power of the beam is same over long time periods; otherwise, the transmission power is zero and the beam is not used.

Therefore, a capability of a serving gNB or a satellite to dynamically adapt a transmit power for transmissions from a beam to a traffic type and/or to a load, for example by decreasing the power in low load scenarios, or in scenarios where the beam causes interference to neighboring cells, or to transmissions by UEs in case of duplex operation, or by increasing the power to provide better coverage for cell edge UEs or better reception for services that require a higher reliability, would be beneficial for energy saving purposes and/or for improving coverage and capacity.

Embodiments of the present disclosure recognize that there is a need to define a UE behaviour when a serving gNB or a satellite changes a transmit power over a beam or over a cell.

Embodiments of the present disclosure further recognize there is another need for the UE to provide information to the serving gNB or satellite of a reception quality of a DL signal or channel at the UE in response to a change in the transmit power over a beam or over a cell.

Embodiments of the present disclosure further recognize there is another need to define the indication associated with a transmission power change in a beam by the serving gNB to the UE.

A serving gNB provides coverage over a cell and transmits signals and channels using a beam with a given beam width and beam direction. In the cell, unless otherwise indicated, a UE may expect to receive SS/PBCH blocks (SSBs), or system information, or CSI-RS indicated by higher layers, or to transmit physical random access channel (PRACH) or SRS using resources indicated by higher layers. Depending on the traffic conditions over the network and/or on the network operation mode, the serving gNB can change a transmit power on a cell and accordingly change the cell area. The transmit power can be for a cell defining signal, such as for a SS/PBCH block or for the secondary synchronization signal (SSS) of the SS/PBCH block. The serving gNB can use a maximum transmit power and provide coverage over a largest cell with the beam, or switch the transmit off and provide no coverage with the beam.

For example, using a same beam, a serving gNB transmits with a first transmit power P1 during a first time interval and with a second transmit power P2 during a second time interval, wherein the second power is smaller than the first power. The coverage area decreases during the second time interval, and the first cell coverage area during the first time interval is larger than the second cell coverage area during the second time interval. For TN or GEO satellites, the cell becomes smaller during the second time interval while the cell center remains the same because the position of the serving gNB or of the GEO satellite is fixed. UEs located in areas at the edge of the cell would be in-coverage when the serving gNB uses the first transmit power, and would be out-of-coverage when the serving gNB uses the second transmit power, thus experiencing a degradation of the signal to noise ratio (SINR) of receptions and not being able to receive signals reliably. For LEO satellites, the coverage area provided by the beam changes over time due to the relative movement of the satellite and the earth, and areas of the satellite footprint that are in-coverage in a first time instance would be out-of-coverage in a second time instance as the satellite moves away, and the transition from in-coverage to out-of-coverage would happen continuously on a time scale that depends on the satellite speed.

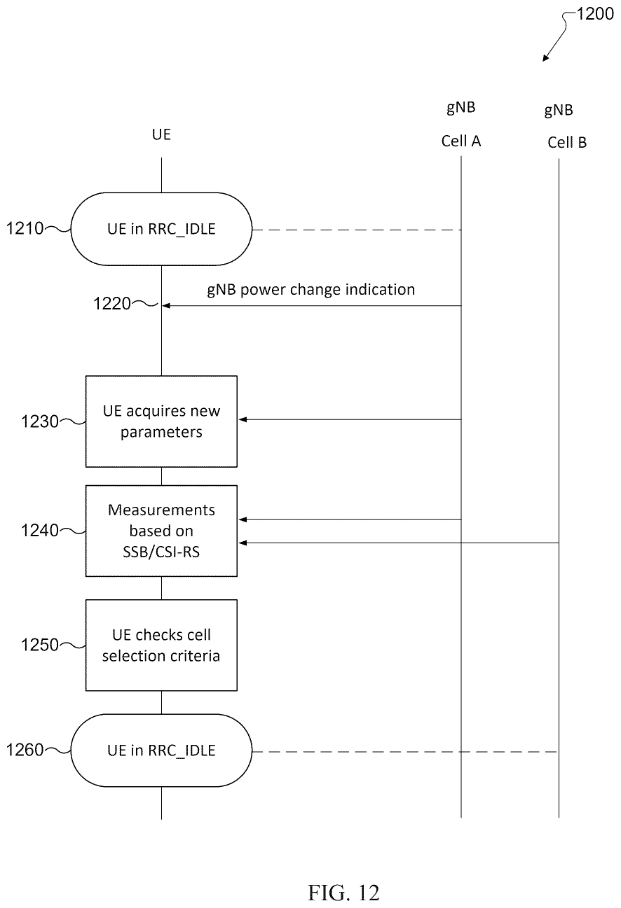

FIG. 12 illustrates a flowchart of an example UE procedure 1200 for cell selection according to embodiments of the present disclosure. For example, procedure 1200 for cell selection can be performed by the UE 111, the gNB 102 and/or network 130, and the gNB 103 and/or the network 130 in the wireless network 100 of FIG. 1. This example is for illustration only and other embodiments can be used without departing from the scope of the present disclosure.

The procedure begins in 1210, a UE is in RRC_IDLE state. In 1220, a gNB in cell A transmits to the UE a gNB transmission power indication. In 1230, the UE acquires new parameters from the gNB in cell A. In 1240, the UE performs measurements based on SSB/CSI-RS receptions from the gNB for cell A and from a gNB for cell B. In 1250, the UE checks cell selection criteria. In 1260, the UE is in RRC_IDLE state.

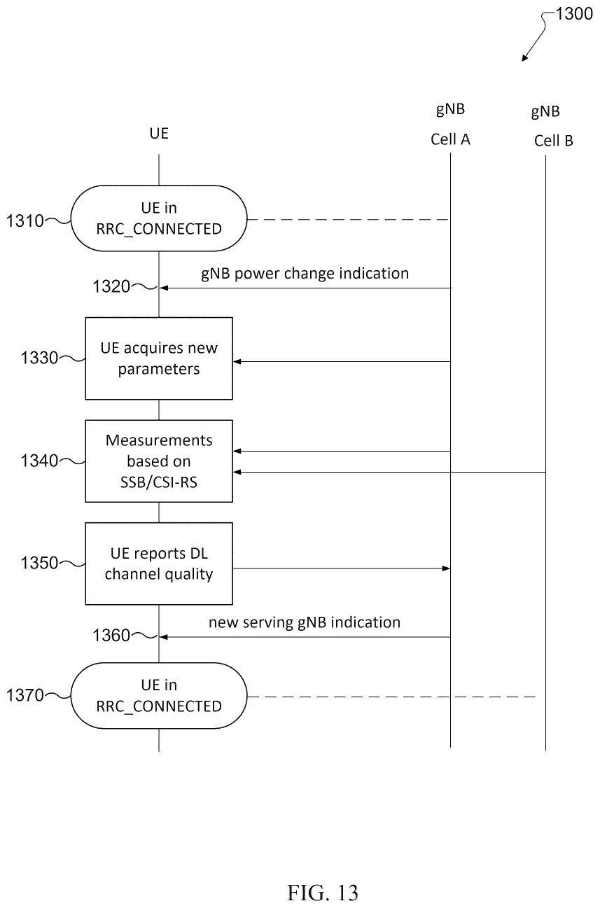

FIG. 13 illustrates a flowchart of an example UE procedure 1300 for cell selection according to embodiments of the present disclosure. For example, procedure 1300 for cell selection can be performed by the UE 112, the gNB 102 and/or network 130, and the gNB 103 and/or the network 130 in the wireless network 100 of FIG. 1. This example is for illustration only and other embodiments can be used without departing from the scope of the present disclosure.

The procedure begins in 1310, a UE is in RRC_CONNECTED state. In 1320, the UE receives gNB power change indication from a gNB in cell A. In 1330, the UE acquires new parameters from the gNB in cell A. In 1340, The UE performs measurements based on SSB/CSI-RS receptions from the gNB for cell A and from a gNB for cell B. In 1350, the UE reports DL channel quality corresponding to the measurements to the gNB in cell A. In 1360, the UE receives new serving gNB indication from the gNB for cell A. In 1360, the UE is in RRC_CONNECTED state.

Cell selection/reselection may be affected by a change in a transmit power of a serving gNB.

A UE in RRC_IDLE or RRC_INACTIVE state performs cell or beam selection and reselection in order to decide on which cell or beam to camp. The UE in RRC_IDLE or RRC_INACTIVE state monitors a paging channel to detect incoming calls, and also acquires system information that mostly includes parameters by which the network (e.g., the network 130) can control the cell (re) selection process. When the serving gNB changes the transmit power from a first transmit power P1 to a second transmit power P2, a UE in RRC_IDLE or RRC_INACTIVE located in areas that would be affected by the gNB transmit power change, such as a UE that would transition from in-coverage to out-of-coverage when the transmit power decreases and transition from out-of-coverage to in-coverage when the transmit power increases, would need to perform cell (re) selection and acquire new parameters that would be used in evaluating a cell selection criterion for the cell selection process, such as minimum required RX level in the cell, or minimum required signal quality level in the cell, or offset to the signaled minimum required signal quality level. The UE derives measurement quantities for the cell based on SS/PBCH blocks or CSI-RS, and thresholds that are configured in one or more SIBs. For example, the UE derives cell selection RX level value (Srxlev) or cell selection quality value (Squal) and, for NTN if the UE supports location-based measurement initiation and has obtained its location information, the UE determines distances between the UE location and the serving cell reference location and compares with configured thresholds and parameters such as distance Thresh, referenceLocation or movingReferenceLocation. The UE checks cell selection criteria periodically. Additionally, the cell selection process can be triggered by the gNB prior to the gNB changing the transmit power from a larger transmit power to a smaller transmit power, or also when changing from a smaller transmit power to a larger transmit power.

With reference to FIG. 12, a cell selection procedure is shown for a UE in RRC_IDLE or RRC_INACTIVE state when the serving gNB changes the transmit power.

A UE in RRC_CONNECTED state provides reports of its buffer status and of the DL channel quality, as well as neighbor cell measurements to enable the network (e.g., the network 130) to select the most appropriate cell for the UE. Similar to the case of a UE in RRC_IDLE or RRC_INACTIVE state, when the serving gNB changes the transmit power from the first transmit power P1 to the second transmit power P2, a UE in RRC_CONNECTED state located in areas that would be affected by the gNB transmit power change would provide DL channel quality report corresponding to the new transmit power, and needs to acquire new parameters, such as thresholds for the measurements or thresholds for triggering a report, that are used for the reporting of the DL channel quality. The UE can provide the DL channel quality report periodically, and additionally the report can be triggered by the gNB prior to the gNB changing the transmit power from a larger transmit power to a smaller transmit power, or also when changing from a smaller transmit power to a larger transmit power.

With reference to FIG. 13, the cell selection procedure is shown for a UE in RRC_CONNECTED state when the serving gNB (e.g., the gNB 102) changes the transmit power.

When a serving gNB changes a transmit power used in a beam, a UE that is provided coverage by the beam may experience beam failure and a beam failure recovery (BFR) mechanism needs to be initiated. A first step of the BFR mechanism is beam failure detection at the UE and is based on a threshold rsrp-ThresholdBFR provided via RRC signaling by the serving gNB that would configure a new value for the threshold when the transmit power changes. Alternatively, the rsrp-ThresholdBFR can be a set of more than one values, instead of a single value, and each element of the set of values can have a one-to-one mapping with a set of transmit powers for a beam. Then, when a UE (e.g., the UE 116) is indicated a new transmit power, the UE can directly determine a threshold value to apply for beam failure detection procedure. For example, the threshold can be smaller when the transmit power decreases in order for the UE to be able to continue to use the same beam with a larger probability. The BFR mechanism at the UE includes beam failure detection, new candidate beam identification, BFR request transmission and monitoring of the response for BFR request. When there is a transmit power change for the beam, the UE would be provided or determine new values for one of more parameters that are configured via RRC signaling in RadioLinkMonitoringConfig, RadioLinkMonitoringRS, BeamFailureRecoveryConfig, PRACH-ResourceDedicatedBFR, BFR-SSB-Resource, or BFR-CSIRS-Resource. Similar to rsrp-ThresholdBFR, the UE can be provided a set of values for each of the parameters herein, wherein each value in the set of values has a one-to-one mapping with a transmit power per beam.

For the BFR mechanism, the UE monitors/receives SS/PBCH blocks or CSI-RSs transmitted periodically by the serving gNB using the beam to assess if a beam failure trigger condition has been met. The UE also monitors/receives SS/PBCH blocks or CSI-RSs transmitted periodically by the serving gNB using a different beam to identify a new candidate beam. A beam failure is detected for a beam if a number of consecutive detected beam failure instances exceeds a configured maximum number NBF within a time interval provided by beamFailureDetectionTimer. Similar to rsrp-ThresholdBFR, the UE can be provided a set of values for NBF or beamFailureDetectionTimer, wherein each value in the set of values has a one-to-one mapping with a transmit power per beam. For example, when the transmit power decreases, NBF can be set to a larger value or the time interval can be set to a larger value so that the UE can have a larger probability of using the current beam. However, as the transmit power decrease may be the main reason for beam failure, to avoid performance degradation and increased latency NBF can be set to a smaller value. A beam failure can be in a beam or can be also in a set of beams configured via RRC message for beam failure detection, and can be detected by PDCCH block error rate (BLER) determined based on reference signal received power (RSRP) measurement of SS/PBCH blocks or CSI-RSs being above a threshold.

After detecting beam failure, the UE initiates a random access procedure for beam recovery, and starts beamFailure RecoveryTimer, if configured. i) the UE selects a contention free PRACH occasion and/or preamble corresponding to the new candidate beam and transmits the preamble. ii) the UE then starts the bfr-ResponseWindow at the start of the first PDCCH occasion after a fixed duration of a number of symbols from the end of the preamble transmission, wherein bfr-ResponseWindow is the random access response (RAR) response window configured by gNB for BFR. iii) the UE monitors the PDCCH scrambled with C-RNTI for response to BFR request while bfr-Response Window is running. iv) if the UE receives a PDCCH that provides a DCI format with CRC scrambled by C-RNTI, the UE evaluates the BFR request procedure successfully completed and stops beamFailureRecoveryTimer. If the bfr-ResponseWindow expires, the UE performs steps i), ii) and iii) again. If the bfr-Response Window expires and the UE has already transmitted PRACH for a configured number of times, the BFR request procedure is regarded unsuccessful and the UE may trigger radio link failure. If beamFailureRecoveryTimer expires and the BFR request procedure is not successfully completed, the UE stops using the contention free random access resources configured for BFR.

A UE can periodically monitor the signal quality/RSRP of a reference signal in the DL, for example the UE performs RSRP measurements based on receptions of an available DL signal over the cell, such as SS/PBCH blocks or CSI-RS. The UE compares a measured RSRP to an RSRP threshold provided by the serving gNB by a cell-specific parameter or by a UE-specific parameter. For example, the cell-specific parameter for an RSRP threshold can be provided via system information and, for example depending on the traffic type for a UE, a UE-specific parameter for an RSRP threshold can be additionally provided by UE-specific RRC signalling in order for the UE to select a cell or a beam that can provide the required reliability for the traffic type. Different values of the RSRP threshold can be configured for different UE types or UE capabilities, and depending on whether or not the UE type or UE capability is known to the serving gNB when the UE is in RRC_IDLE or RRC_INACTIVE state, the RSRP threshold can be configured as UE-specific or UE-group-specific parameter by higher layers. The serving gNB provides a first cell-specific RSRP threshold for RSRP measurements in RRC_IDLE state and a second UE-specific or UE-group-specific RSRP threshold for RSRP measurements in RRC_CONNECTED state. For example, for a UE in RRC_IDLE or RRC_INACTIVE state, the threshold can be smaller than for a UE in RRC_CONNECTED in order for the UE to be able to select the cell with a larger probability. If the traffic type for the UE requires high data rates or high reliability, the RSRP threshold can be larger for a UE to continue searching for another cell or beam; otherwise, the RSRP threshold indicated to a UE in RRC_IDLE or RRC_INACTIVE state may not be modified by an additional UE-specific parameter.

An indication by a gNB of a transmit power change, including a reduction to zero, can be provided by DCI format or MAC CE on the active DL BWP of a serving cell, and can be a group indication or a UE-specific indication (corresponding PDCCH/PDSCH received based on a CSS set or a USS set). The indication of a power change can be a first stage indication, followed by a second stage indication that can be a request for measurements, or a scheduling grant, or an indication of a spatial setting, or a request to transmit SRS. The first indication of the power change can be a group signaling, such as via a DCI format in a PDCCH provided in a CSS set or via a PDSCH scheduled by such a DCI format, and the second indication can be via a UE-specific signaling, such as via a DCI format in a PDCCH provided in a USS set or via a PDSCH scheduled by such a DCI format. Whether and how the UE receives the second indication after the first indication can be subject to a UE state, for example whether the UE is in RRC_IDLE or RRC_INACTIVE or RRC_CONNECTED state, or to a cell operation. For example, whether the UE is configured for operation on a serving cell according to one or both of a cell discontinuous transmission (DTX) operation and a cell DRX operation by cellDTXDRX-Config for the serving cell, or whether the UE receives on the active DL BWP of the serving cell a PDCCH providing DCI format 2_9 that indicates a change in activation or deactivation of cell DTX operation for the serving cell.

An indication of power change can be provided by a field in a DCI format or in a MAC CE that includes, for example, N bits wherein M₁ of the 2^{μ} values can map to a power decrease, including to zero, and remaining M₂=2^{N}−M₁ values can map to a power increase, including no power change. The mapping of the values of the field to power change values can be provided by higher layers such as by system information or by UE-specific RRC signaling. The DCI format or the MAC CE can include multiple fields for corresponding multiple serving cells. The UE can also be indicated by higher layers, such as by UE-specific RRC signalling, a mapping for a location of the field, for example in a DCI format, to a serving cell.

In one embodiment, a UE (e.g., the UE 116) performs RSRP measurements based on receptions of SS/PBCH blocks or CSI-RS and, based on the indicated RSRP threshold, if a measured RSRP is below the indicated RSRP threshold, the UE determines that the UE is not in-coverage, stops receiving and/or transmitting signals or channels, and transitions to a low power consumption state such as a sleep state, or transitions to DRX (discontinuous reception) mode for the serving cell; otherwise, the UE continues to communicate on the serving cell. With reference to FIG. 11, the UE transition from normal mode to DRX mode can happen when the serving gNB decreases the power so that the coverage area decreases from C2 to C1, and the UE is located in the area outside C1 and inside C2. If the serving cell is a secondary cell (SCell), the UE behaviour can follow similar procedures as when the SCell is deactivated or is in dormancy for the UE. For example, the UE may stop transmissions/receptions or the UE may only transmit and receive a subset of signals/channels, such as transmit SRS or receive CSI-RS. If the serving cell is a primary cell, the UE can perform procedures for cell reselection, similar to when the UE moves out of coverage for a serving cell due to mobility without the serving cell change as a change in a transmission power from a gNB on a serving cell is similar to an increase to a pathloss that the UE experiences as the UE moves out of cell coverage. The UE behaviour, such as to expect deactivation or dormancy for an SCell, can be indicated by the gNB.

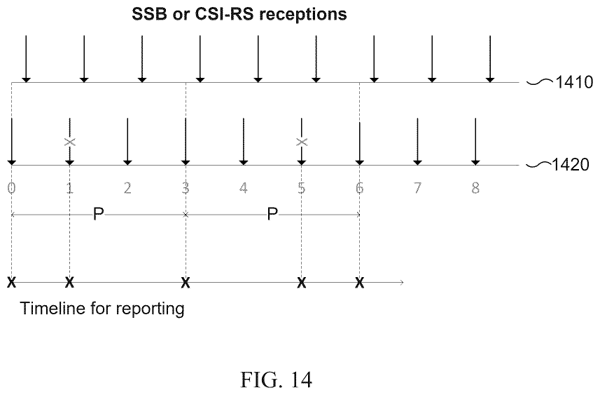

FIG. 14 illustrates example timelines 1410 and 1420 for reception and reporting, respectively, according to embodiments of the present disclosure. For example, timelines 1410 and 1420, respectively, for reception and reporting can be followed by any of the UEs 111-116 of FIG. 1, such as the UE 113. This example is for illustration only and other embodiments can be used without departing from the scope of the present disclosure.

When the UE is in DRX mode, such as when the UE expects an SCell is in dormancy mode or is deactivated for the UE, the UE may wake-up, periodically or based on an indication by a serving gNB for example through a DCI format in a PDCCH reception on another cell and perform RSRP measurements based on SS/PBCH blocks or CSI-RS receptions on the SCell. In case of periodic RSRP measurements, a periodicity for the RSRP measurements can be configured by the serving gNB or can be associated to a UE capability or a UE type and can be preconfigured or fixed. The periodicity P for the UE to perform RSRP measurements can be an integer number that is a multiple of the periodicity of the configured SS/PBCH blocks or CSI-RS, including equal to the periodicity of the SS/PBCH blocks or CSI-RS on the serving cell such as the SCell. The UE is configured with a periodicity P for RSRP measurements, and the UE determines which SS/PBCH blocks or CSI-RS within the period P to use for RSRP measurements. For example, the UE can be configured to use a single reception of SS/PBCH or CSI-RS within the period P for the measurements, and report the corresponding RSRP. The timeline for reporting can be associated with the start or with the end of the period P that includes the SS/PBCH or CSI-RS reception used for the reported RSRP, or with the actual time instance of the SS/PBCH or CSI-RS reception used for the reported RSRP, and can be indicated by the gNB (e.g., the BS 102).

With reference to FIG. 14, in a first period P the UE can measure RSRPs at time instances 0,1,2, and report the largest RSRP corresponding to the SS/PBCH or CSI-RS received at time instance 1 using a timeline corresponding to time instance 0 or 1 or 4. The periodicity of SS/PBCH or CSI-RS can be aligned (timeline 1420) or not aligned (timeline 1410) with the periodicity P. Instead of the largest RSRP, the UE may report a predetermined number of RSRPs for a corresponding number of time instances.

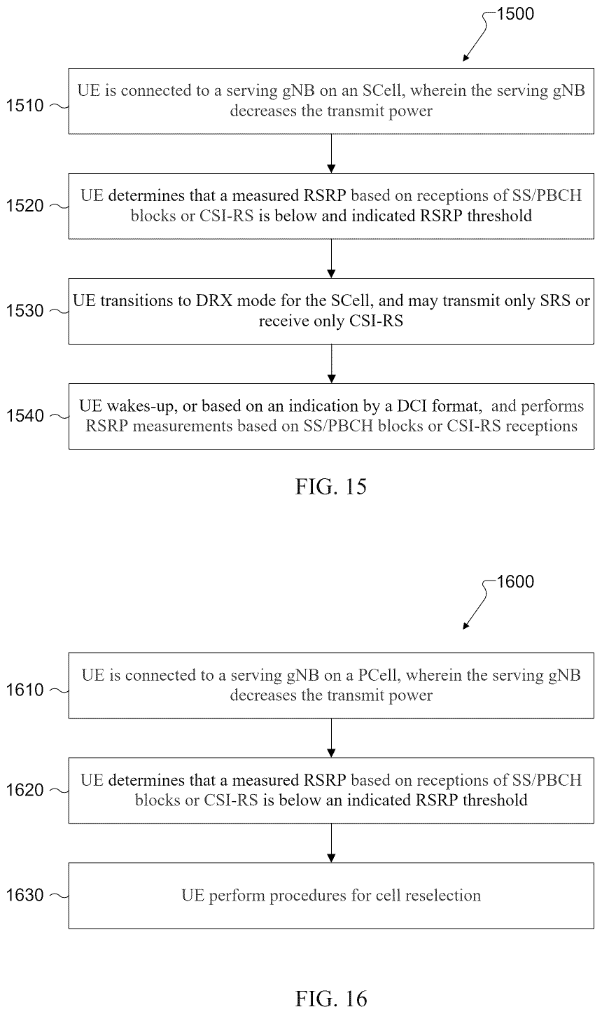

FIG. 15 illustrates a flowchart of an example UE procedure 1500 for transitioning to a DRX mode according to embodiments of the present disclosure. For example, procedure 1500 for transitioning to a DRX can be followed by any of the UEs 111-116 of FIG. 1, such as the UE 114. This example is for illustration only and other embodiments can be used without departing from the scope of the present disclosure.

The procedure begins in 1510, a UE is connected to a serving gNB on an SCell, wherein the serving gNB decreases the transmit power. In 1520, the UE determines that a measured RSRP based on receptions of SS/PBCH blocks or CSI-RS is below an indicated RSRP threshold. In 1530, the UE transitions to DRX mode for the SCell, and may transmit only SRS or PRACH or receive only CSI-RS. In 1540, the UE wakes-up, based on an indicated timer or based on an indication by a DCI format, and performs RSRP measurements based on SS/PBCH blocks or CSI-RS receptions.

With reference to FIG. 15, an example procedure is shown for a UE to transition to a DRX state on an SCell when the serving gNB on the SCell decreases a transmit power according to the disclosure.

FIG. 16 illustrates a flowchart of an example UE procedure 1600 for transitioning to a DRX mode according to embodiments of the present disclosure. For example, procedure 1600 for transitioning to a DRX mode can be followed by any of the UEs 111-116 of FIG. 1, such as the UE 115. This example is for illustration only and other embodiments can be used without departing from the scope of the present disclosure.

The procedure begins in 1610, a UE is connected to a serving gNB on a PCell, wherein the serving gNB decreases the transmit power. In 1620, the UE determines that a measured RSRP based on receptions of SS/PBCH blocks or CSI-RS is below an indicated RSRP threshold. In 1630, the UE perform procedures for cell reselection.

With reference to FIG. 16, an example procedure is shown for a UE to transition to a DRX state on a PCell when the serving gNB on the PCell decreases a transmit power according to the disclosure.

When the UE is in DRX mode, the UE may only transmit SRS or PRACH or receive CSI-RS. The serving gNB can determine a channel quality using SRS or PRACH receptions. Based on the channel quality determined by the serving gNB from SRS or PRACH receptions, the serving gNB may change the gNB transmission power of the one or more beams used in the cell, including a reduction to zero of one or more beams.

The UE may periodically transmit SRS or PRACH while in DRX mode, with a periodicity that can be configured by the serving gNB or can be associated to a UE capability or a UE type or an operating mode (e.g. DRX mode, deep/light sleep) or can be (pre) configured or fixed. The UE may also be configured to monitor PDCCH, on the cell with the DRX mode or on another cell, wherein the PDCCH provides a DCI format triggering SRS or PRACH transmission. Instead of or in addition to PDCCH monitoring, the UE can be configured to receive a wake-up signal, such as a low power (LP) signal enabling operation with low power consumption at the UE, and triggering SRS or PRACH transmission. After the periodic SRS or PRACH transmission or the SRS or PRACH transmission triggered by the serving gNB, the UE may return in DRX mode or may monitor for a PDCCH reception providing a DCI format, or for a PDSCH providing a MAC CE, indicating to the UE a transmission power increase or decrease, or to exit the DRX mode for the serving cell, or to start a random access procedure, or to transmit a PRACH.

Based on the channel quality determined by the serving gNB from SRS or PRACH receptions, the serving gNB may increase or decrease the transmission power over the serving cell and indicate to the UE to start a cell selection process. The serving gNB may instruct the UE to perform and report measurements based on CSI-RS or SS/PBCH receptions from a set of serving cells. The serving gNB may instruct the UE to transmit a PRACH, or to start a random access procedure, on a cell from the set of serving cells.

Based on the channel quality determined by the serving gNB from SRS or PRACH receptions, the serving gNB may increase or decrease the transmission power of the one or more beams used in the cell, including a reduction to zero of one or more beams.

The descriptions mentioned herein for triggering SRS or PRACH transmission are also directly applicable to triggering a CSI-RS reception and subsequent RSRP report in a physical uplink control channel (PUCCH) or PUSCH as is further subsequently described.

In one example, the serving gNB uses a single beam. UEs located in the coverage area of the beam transmit SRS or PRACH, and the serving gNB estimates a channel quality associated with the beam based on SRS or PRACH receptions. If the channel quality is below a configured threshold, the UE may receive a request to perform measurements based on CSI-RS or SS/PBCH and report the measurements to the serving gNB. Based on SRS or PRACH measurements at the gNB, or based on CSI-RS or SS/PBCH measurements by a UE and report to a gNB, the serving gNB may change the direction and beamwidth of the beam.

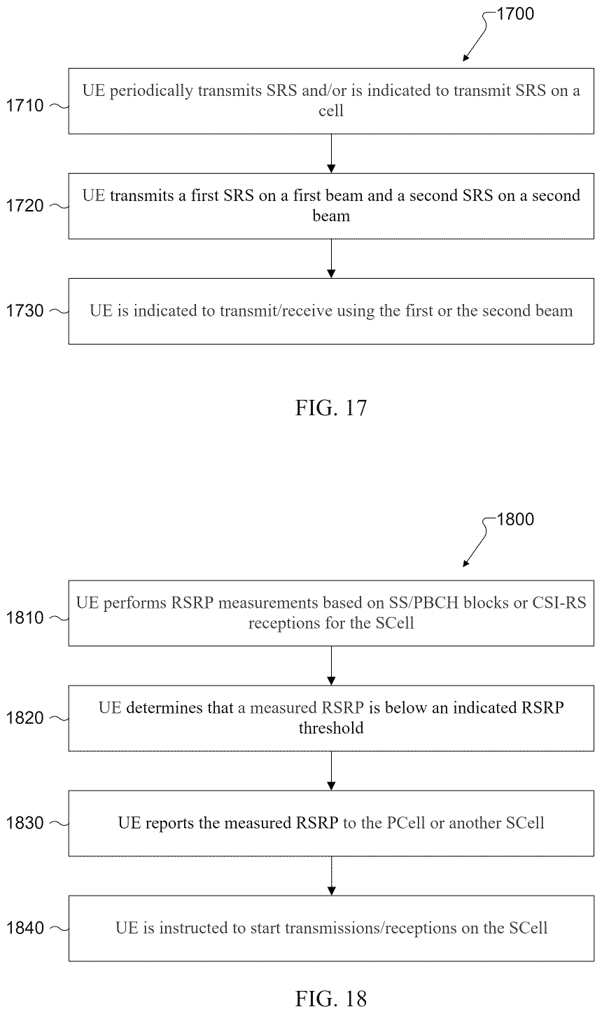

FIG. 17 illustrates a flowchart of an example UE procedure 1700 for transmitting SRS according to embodiments of the present disclosure. For example, procedure 1700 for transmitting SRS can be followed by the UE 116 of FIG. 3. This example is for illustration only and other embodiments can be used without departing from the scope of the present disclosure.

The procedure begins in 1710, a UE periodically transmits SRS and/or is indicated to transmit SRS on a cell. In 1720, the UE transmits a first SRS on a first beam and a second SRS on a second beam. In 1730, the UE is indicated to transmit/receive using the first or the second beam.

In one example, the serving gNB uses two beams and the coverage areas of the two beams do not overlap. UEs located in the coverage area of the first beam transmit SRS (or PRACH), and the serving gNB estimates a first channel quality of the first beam based on the SRS receptions in the first beam. UEs located in the coverage area of the second beam transmit SRS, and the serving gNB estimates a second channel quality of the second beam based on the SRS receptions in the second beam. Similar to the single beam case, for each of the two beams, if the channel quality is below a configured threshold, the UE may receive a request to perform measurements based on CSI-RS or SS/PBCH and report the measurements to the serving gNB. Based on SRS, CSI-RS, or SS/PBCH measurements, the serving gNB may change the direction and beamwidth of the beam.

In one example, the serving gNB uses two beams and the coverage areas of the two beams partially overlap. UEs located in the overlapped area transmit SRS or PRACH using a first and a second uplink beams, and the serving gNB estimates a first and a second channel quality. If the first or second channel quality is below a threshold, or generally based on the value of the first channel quality and/or the second channel quality, the serving gNB indicates to the UE the best beam.

With reference to FIG. 17, an example procedure is shown for a UE to transmit SRS used by a gNB to estimate a channel quality and to receive a beam indication according to the disclosure.

FIG. 18 illustrates a flowchart of an example UE procedure 1800 for reporting measurements according to embodiments of the present disclosure. For example, procedure 1800 for reporting measurements can be followed by any of the UEs 111-116 of FIG. 1, such as the UE 111. This example is for illustration only and other embodiments can be used without departing from the scope of the present disclosure.

The procedure begins in 1810, a UE performs RSRP measurements based on SS/PBCH blocks or CSI-RS receptions for the SCell. In 1820, the UE determines that a measured RSRP is below an indicated RSRP threshold. In 1830, the UE reports the measured RSRP to the PCell or another SCell. In 1840, the UE is instructed to start transmissions/receptions on the SCell.

When the UE periodically performs RSRP measurements based on SS/PBCH blocks or CSI-RS receptions, the UE can report the measurement to the serving gNB. The UE can be configured, or it can be defined in the specifications of system operation, to report an RSRP measurement only when the measured RSRP is above the RSRP threshold. If the RSRP measurement is for an SCell, the UE can provide the RSRP measurement report to the PCell or another SCell. The UE may then be instructed to start transmissions/receptions on the SCell or, if synchronization for the SCell is required, to transmit a PRACH on the SCell. If the RSRP measurement is for the PCell, the UE may start a random access procedure on the primary cell.

In one example, a UE in RRC_IDLE or RRC_INACTIVE state performs RSRP measurements based on receptions of SS/PBCH blocks or CSI-RS with a periodicity P on a first cell or based on a triggering for example by a low-power wake-up signal and, based on the indicated RSRP threshold, a measured RSRP is below an indicated RSRP threshold.
In a first sub-example, the first cell is an PCell and the UE in RRC_IDLE or RRC_INACTIVE state initiates a cell or beam selection procedure to select a new PCell or new beam to camp on by performing measurements on one or more other cells or beams according to a configuration provided via RRC signalling or indicated via MAC CE or by a DCI format if the information is requested by the UE after receiving the indication of a power decrease in the first PCell or first beam. Beams can be indicated by a DCI format or by MAC CE. The UE reports the measurements to the first cell, receives instructions to camp on one of the other cells and may perform synchronization on the cell where the UE would camp on. The UE selects the cell to camp on and may perform synchronization on the selected cell. The UE is indicated a beam to use for a first uplink transmission, and the UE performs synchronization or starts a RA procedure by transmitting a first PRACH using the indicated beam.
In a second sub-example, the first cell is an PCell and the UE in RRC_IDLE or RRC_INACTIVE state is provided an indication of another cell or beam and then performs measurements based on receptions of SS/PBCH blocks or CSI-RS with a configured periodicity on the other cell or beam. Measurements are reported to the other cell that may instruct the UE to perform a RA procedure or to perform synchronization. The UE autonomously starts a RA procedure on the other SCell after providing the measurements.
In a third sub-example, the first cell is a PCell and the UE in RRC_IDLE or RRC_INACTIVE state provides measurements of a set of cells to the PCell. The UE receives instructions from the PCell on which cell from the set of cells to camp on.
In a fourth sub-example, the UE in RRC_IDLE or RRC_INACTIVE state performs measurements of the first cell for a time period after receiving the indication of a power change, wherein the duration of the time period can be configured via RRC or indicated by MAC CE or DCI format or fixed, and the indication to perform and report such measurements is provided in the same signalling that indicates the power change. Measurements are reported to the first cell.
In a fifth sub-example, the UE in RRC_IDLE or RRC_INACTIVE state starts measurements on other cells after the measured RSRP on the first cell is below a second indicated RSRP threshold that is smaller than the first indicated RSRP threshold.

In one example, the UE in RRC_CONNECTED state performs RSRP measurements based on receptions of SS/PBCH blocks or CSI-RS with a periodicity P, or based on an indication by a MAC CE or DCI format, on a PCell using a first beam and, based on the indicated RSRP threshold, when a measured RSRP is below an indicated RSRP threshold. The UE is provided via RRC signalling, for measurements and reports, configurations of SS/PBCH and CSI-RS resources and resource sets.
In a first sub-example, the UE performs measurements in the configured resources, reports (to the PCell and/or the SCells) measurements associated with configured SCells, and is indicated an SCell from the SCells as the new PCell. The UE then starts transmitting/receiving in the new PCell.
In a second sub-example, the UE performs measurements in the configured resources, reports measurements to the PCell associated with a set of beams in the PCell and is indicated a beam from the set of beams in the PCell. The UE then starts transmitting/receiving using the indicated beam in the PCell.

With reference to FIG. 18, an example procedure is shown for a UE to report measurements according to the disclosure.

With reference to FIG. 11, the UE transition from DRX mode to normal mode can happen when the serving gNB increases the transmit power used in the beam that covers C1 and/or increases the beam width and/or steers the beam so that the coverage area is extended from C1 to C2, and the UE is located in the area outside C1 and inside C2, or when the UE moves from outside C1 to inside C1.

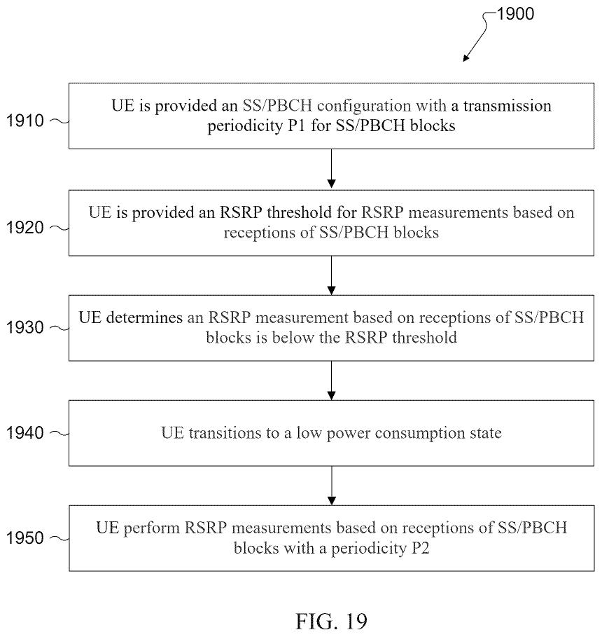

FIG. 19 illustrates a flowchart of an example UE procedure 1900 for transitioning to a low power consumption state and performing RSRP measurements. For example, procedure 1900 for transitioning to a low power consumption state and performing RSRP measurements can be followed by any of the UEs 111-116 of FIG. 1, such as the UE 112. This example is for illustration only and other embodiments can be used without departing from the scope of the present disclosure.

The procedure begins in 1910, a UE is provided an SS/PBCH configuration with a transmission periodicity P1 for SS/PBCH blocks. In 1920, the UE is provided an RSRP threshold for RSRP measurements based on receptions of SS/PBCH blocks. In 1930, the UE determines an RSRP measurement based on receptions of SS/PBCH blocks is below the RSRP threshold. In 1940, the UE transitions to a low power consumption state. In 1950, the UE performs RSRP measurements based on receptions of SS/PBCH blocks with a configured periodicity P2, wherein the periodicity P2 is a multiple of the periodicity P1. Additionally, the periodicity P2 can be indicated by the serving gNB.

In order for the serving gNB (e.g., the gNB 102) to determine whether or not to increase a transmission power on an cell, the gNB can indicate to a UE (e.g., the UE 116) that is in DRX mode to perform measurements on the cell, such as RSRP measurements based on an SS/PBCH block or on a CSI-RS, and report those measurements. The indication can be provided by a “wake-up” signal, a DCI format or by MAC CE. The DCI format can be provided in a PDCCH reception according to a common search space set or a UE-specific search space set. The “wake-up” signal, PDCCH reception, or a PDSCH reception providing the MAC CE, can be on another serving cell such as the primary cell. Similar, the UE can report the measurements on another serving cell, such as the PCell.

In order for the serving gNB to determine whether or not to increase a transmission power on the PCell, a UE that is in DRX mode on the PCell can be indicated in advance to monitor PDCCH according to a corresponding search space set, or to receive another signal such as a wake-up signal, for an indication of whether or not to perform measurements or for an indication to exit the DRX mode, for example because the gNB increases a transmission power on the PCell.

An indication to the UE to perform measurements can include an indication of SS/PBCH block parameters, such as indexes, pattern, or periodicity of transmission, or an indication of CSI-RS resources that the UE would use to perform the measurements. Alternatively, those resources can be configured in advance to the UE by higher layer signaling such as RRC signaling.

The indication by the serving gNB can also include the transmission power of the signal that the UE uses for measurements. For example, for RSRP measurements based on SS/PBCH blocks, the transmission power can be the one of the SS/PBCH block or of the SSS of the SS/PBCH block. When the gNB transmits SS/PBCH blocks associated with multiple respective indexes, the indication can be for the transmission power per SS/PBCH block index in order to enable the gNB to use different transmission powers for different beams associated with the different SS/PBCH block indexes. For example, for RSRP measurements based on CSI-RS, the transmission power can be the one of the CSI-RS. When the gNB transmits CSI-RS associated with multiple TCI states (multiple respective QCL properties), the indication can be for the transmission power per TCI state in order to enable the gNB to use different transmission powers for different beams associated with the different TCI states. The TCI states can be indicated to the UE by higher layers.

The indication by the serving gNB can also include a time for the transmission of the SS/PBCH blocks or of the CSI-RS relative to the time of the PDCCH providing the DCI format, or of the PDSCH providing the MAC CE, which includes the indication. For example, the time can be an offset in number of slots or in milliseconds from the slot of the PDCCH or PDSCH reception or from the end of the PDCCH or PDSCH reception.

The indication by the serving gNB can also include a request for the UE to transmit SRS in resources configured for SRS transmissions, wherein SRS resources can be separately configured for SRS transmissions for the UE in RRC_IDLE or RRC_INACTIVE state or for the UE in RRC_CONNECTED state. The request for SRS transmission can be for the UE to transmit SRS to the serving gNB on the current serving cell that can be a PCell or an SCell, or for the UE to transmit SRS on another SCell.

Instead of a PDCCH reception providing a DCI format, or of a PDSCH providing a MAC CE, indicating to the UE to exit the DRX mode for a serving cell, the UE can be configured to receive a paging or a wake-up signal. That configuration can also depend on the type of UE based on a respective UE capability or depend on a sleep mode of the during DRX mode. For example, when the UE monitors PDCCH on another serving cell, the indication for the UE to perform measurements on the serving cell where the UE is in DRX mode can be provided by a DCI format or a MAC CE while when the UE does not monitor PDCCH on another serving cell, the indication can be provided by paging or by a low power wake-up signal.

With reference to FIG. 19, an example procedure is shown for a UE to transition to a low power consumption state and to perform RSRP measurements based on SS/PBCH block receptions according to the disclosure.

A UE performs RSRP measurements of SS/PBCH block receptions and, based on the configured RSRP threshold, if a measured RSRP is below the configured RSRP threshold, the UE provides a measurement information, such as a report based on SS/PBCH block receptions or a CSI report, to the serving gNB.

In one example, a UE can provide measurement information through a PUCCH transmission that includes information bits, wherein the information bits include a first number of bits for the measurement report and a second number of bits to indicate the location.

In one example, a UE can provide measurement information through a PUCCH transmission that includes information bits, wherein the information bits are bits to indicate the UE location.

In one example, a UE can provide measurement information through a PUCCH transmission that includes information bits, wherein the information bits include 1-bit to indicate that the measured RSRP is below the configured RSRP threshold or to indicate a request to provide RSRP measurements for respective SS/PBCH blocks associated with respective indexes.

In one example, a UE can provide measurement information through a PUCCH transmission that includes information bits. If the number of information bits is not larger than 2, a serving gNB can provide to the UE a PUCCH resource, associated for example with PUCCH format 1, for the UE to use for a PUCCH transmission providing measurement information. If the number of information bits is larger than 2, the serving gNB can provide to the UE a PUCCH resource, associated for example with PUCCH format 2, 3, or 4, or a PUSCH resource for the UE to use for a PUCCH or PUSCH transmission providing measurement information.

In one example, a UE can provide measurement information together with other uplink control information (UCI), such as a scheduling request (SR), in a PUCCH transmission or together with BSR in a PUSCH transmission. Alternatively, the UE can provide measurement information by higher layers, such as a MAC control element (CE), in a PUSCH transmission.

When a UE provides measurement information through a PUCCH or a PUSCH transmission, the UE transmits the PUCCH or PUSCH in transmission occasions that are indicated by a UE-specific RRC signaling when resources for the PUCCH or PUSCH transmissions are UE-specific, or by a cell-specific RRC signaling when resources for the PUCCH or PUSCH transmissions are cell-specific, or by a DCI format. The UE-specific signaling has the advantage that those PUCCH or PUSCH resources can be distributed in time and a required PUCCH resource overhead in a particular slot would be reduced. The cell-specific signaling has the advantage that fewer PUCCH or PUSCH resources can be required, however there can be multiple UEs needing resources at the same time and there can be collisions among UEs.

When a UE (e.g., the UE 116) provides measurement information through a PUCCH or a PUSCH transmission, the UE transmits the PUCCH or PUSCH in transmission occasions that are associated with a DL signaling reception. For example, a serving gNB can request to the UE to report a measurement information by sending an indication in a DCI format included in a PDCCH, and the transmission occasions for reporting the measurement information can be defined by a time offset, such as a time offset relative to a (smallest) periodicity of PDCCH monitoring occasions providing the DCI format or can be indicated by the DCI format. The transmission occasions for reporting measurement information can be common to a group of UEs including UEs with a same serving gNB, for example PDCCH monitoring occasions associated with the DCI format are determined by corresponding search space sets, such as CSS sets, and the time offset can be provided by a SIB or can be indicated by the DCI format. Multiple corresponding transmission occasions can be associated with a PDCCH monitoring occasion for the DCI format.

In one example, a UE can provide measurement information through a PRACH preamble transmission wherein the PRACH preamble is from a set of PRACH preamble configured for measurement report, and the PRACH preamble is transmitted in random access occasions (ROs) that are mapped to SS/PBCH block indexes or to CSI-RS. The UE transmits the PRACH preamble to indicate that a measured RSRP for a corresponding SS/PBCH block index or CSI-RS is below a configured RSRP threshold. The UE can also transmit the PRACH preamble with repetitions in multiple ROs that are associated with a same SS/PBCH block index or a same CSI-RS. The UE transmits the PRACH preamble with repetitions in multiple ROs that are associated with corresponding multiple SS/PBCH block indexes or with multiple CSI-RS.

In one example, prior to decreasing a transmit power a serving gNB sends an indication that triggers a power headroom report (PHR) by the UE. Upon reception of the indication to provide the PHR, the UE provides the PHR based on a PUSCH transmission and/or provides a P_{CMAX,f,c}(i) value and starts monitoring for a PDCCH reception according to a common search space set or a UE-specific search space set, wherein the PDCCH reception schedules a PDSCH reception that provides a MAC CE, or includes a DCI format, that indicates another serving cell or another beam. Alternatively, the UE starts monitoring for a PDCCH reception according to a common search space set or a UE-specific search space set on another serving cell or another beam.

In one example, prior to decreasing a transmit power, a serving gNB (e.g., the BS 102) sends an indication that triggers a power class report or a delta power class report by a UE. For example, a UE that is capable of operating with a first power class and a second power class, wherein the second power class implies a higher transmit power, and is operating with the first power class, upon reception of the indication of transmit power increase or decrease by the serving gNB, the UE reports its power class. Whether the UE changes power class and operates at a higher or lower power class as a consequence of the indication by the serving gNB can be subject to a configuration and/or to a UE capability. In response to the gNB indication, the UE may report the power class that the UE would use after a change of operating power class, if any. The UE reports an information associated with the UE transmit power corresponding to the first power class, or to the second power class, or to both the first and second power class. After the power class report, the UE starts monitoring for a PDCCH reception according to a common search space set or a UE-specific search space set, wherein the PDCCH reception schedules a PDSCH reception that provides a MAC CE, or includes a DCI format, which indicates another serving cell or another beam. Alternatively, the UE starts monitoring for a PDCCH reception according to a common search space set or a UE-specific search space set on another serving cell or another beam.

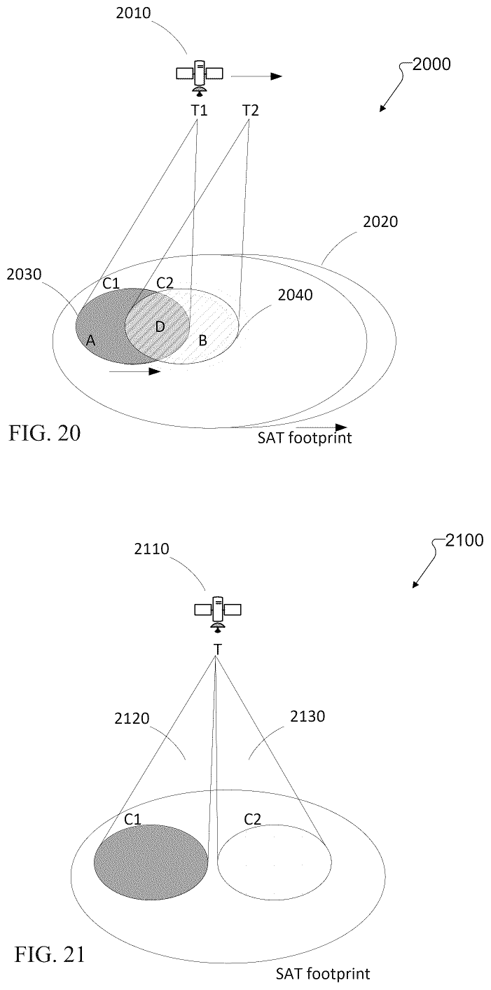

FIG. 20 illustrates a diagram of an example NTN 2000 according to embodiments of the present disclosure. For example, the UE 116 of FIG. 3 can operate within the NTN 2000. This example is for illustration only and other embodiments can be used without departing from the scope of the present disclosure.

As shown in FIG. 20, the NTN 2000 includes satellite 2010, satellite footprint 2020, C1 2030, and C2 2040.

When a satellite moves from a first position at time T1 to a second position at time T2, wherein the satellite uses a beam to provide coverage for a UE that is located within the area A of C1 of FIG. 20, at time T2 the UE would be out of coverage of the beam, and the satellite would provide coverage to the UE by activating another beam or by adapting the current beam. When the UE approaches the cell edge area of the coverage area of the beam, a radio link quality would degrade and the UE would detect a beam failure based at least on a configured RSRP threshold. As the transition from in coverage to out of coverage may happen fast, the UE needs to monitor the radio link quality for beam failure detection early enough to be able to start using a new beam for transmissions and receptions.

Therefore, embodiments of the present disclosure further recognize that there is a need for a UE to determine when to start monitoring for beam failure detection.

There is another need for a UE to determine a new beam for transmissions and receptions after a beam failure detection occurs.

There is also another need to define procedures for beam failure recovery (BFR) that a UE would apply in order to change beam for receptions after beam failure detection occurs or after a condition is met. Assistance information provided by the UE to the satellite or to the serving gNB for the BFR mechanisms can include, but is not limited to, RSRP measurements based on SS/PBCH blocks or CSI-RSs receptions, or information associated with UE location, or information associated with UE-satellite/gNB distance information.

In the following, unless otherwise explicitly noted, providing a parameter value by higher layers includes providing the parameter value by a system information block (SIB), such as a SIB1, or by a common RRC signaling, or by UE-specific RRC signaling.

The following descriptions and embodiments for a UE performing measurements and corresponding measurement reporting equally apply when measurements and reporting by the UE are based on SS/PBCH block receptions or CSI-RS receptions.

For LEO satellites, or generally for satellites and aerial platform that are not geostationary, as illustrated in FIG. 20, the coverage area provided by a beam within a satellite footprint (2020), changes overtime from C1 (2030) at time T1 to C2 (2040) at time T2 due to the relative movement of the satellite or aerial platform (2010) and the earth. Parts of C1 would transition from in-coverage to out-of-coverage as the satellite moves away, and the transition from in-coverage to out-of-coverage happens on a time scale that depends on the satellite speed.

While moving from T1 to T2, the satellite can keep active a beam with a same beam width and a same direction, and the coverage area changes from C1 to C2. A UE that is in the area A of C1, at time T2 would be out of coverage, and the satellite would provide coverage by activating another beam or by increasing the power of the current beam or by changing the beam width and/or the direction of the current beam. In C1, the UE may expect to receive SS/PBCH blocks or system information or CSI-RS indicated by higher layers, or to transmit PRACH or SRS using resources indicated by higher layers, and when the quality of receptions at the UE and/or at the satellite degrades below a certain threshold, the satellite would provide coverage by adapting the power and/or the beam width and/or the direction of the current beam, or by activating a new beam. Threshold values can be different when determining the quality of receptions at the UE or at the satellite, and procedures to initiate the beam adaptation can be different depending on the UE location and on whether the UE is in RRC_IDLE or RRC_INACTIVE state or in RRC_CONNECTED state.

As the satellite moves, the area C1 would eventually be outside of the satellite footprint, and the UE would handover to another satellite, or generally to another serving gNB. A criterion for detecting the degradation of the quality of receptions at the UE and/or at the satellite in order to start a handover procedure to another satellite can be different from the one used for changing beam or adapting the current beam within the satellite footprint. For example, thresholds for determining the reception quality at the UE and/or at the satellite can be different for handover to another satellite, or the criterion for initiating the handover can be based on the UE location. Latency needs also to be evaluated as the handover procedure may require additional time respect to the beam change within the satellite footprint.

FIG. 21 illustrates a diagram of an example NTN 2100 according to embodiments of the present disclosure. For example, any of the UEs 111-116 of FIG. 1, such as the UE 111, can operate within the NTN 2100. This example is for illustration only and other embodiments can be used without departing from the scope of the present disclosure.

As shown in FIG. 21, the NTN 2100 includes satellite 2110, C1 2120, and C2 2130.

To optimize network energy savings and use of available power, the satellite can estimate whether in an area along the satellite trajectory that is not yet in coverage, there would be a need to provide coverage or the satellite can switch off the beam that would serve the area. As illustrated in FIG. 21, at time T the satellite (2110) provides coverage over C1 (2120) and activates a beam over C2 (2130) to estimate whether to keep active the same beam (with same beam width and same direction) that currently provides coverage for C1 at the time that the beam would provide coverage for C2, and/or whether to adapt the transmit power or the beam width or the beam. At any given time, the satellite would keep active a first set of beams to provide coverage in a first area, and use a second set of beams to estimate whether to provide coverage in a second area. Beam widths, directions and transmit powers of the first set and the second set of beams would be determined by the satellite based on a quality of receptions at the UE and/or at the satellite that is subject to different requirements and criteria for the first set and the second set of beams, and for beams within the first or second set of beams.

FIGS. 10, 20, and 21 are shown according to embodiments of the present disclosure, and are for illustration purposes only. A coverage area provided by a beam, also referred as a cell, and a number of beams within a satellite footprint can vary substantially. There can be tens or hundreds of beams within a satellite footprint, of which none or some or each can be active at the same time. Beams within the satellite footprint can use same or different BWPs or frequency ranges, transmit powers, beam widths, beam directions. Moreover, an area can be served only by a downlink beam for a given time period, and single or multiple beams in the uplink can be active only for a portion of time while the downlink beam is active. In other words, a cell DTX operation and a cell DRX operation can be implemented flexibly over a cell in time and/or frequency, and differently in cells of the satellite footprint. Other embodiments of a non-terrestrial network, shown in FIGS. 10, 20, and 21, could be used without departing from the scope of this disclosure, and could include a terrestrial network.

When a satellite moves from a first position at time T1 to a second position at time T2, wherein the satellite uses a beam to provide coverage for a UE that is located within the area A of C1 of FIG. 20, at time T2 would be out of coverage of the beam, and the satellite would provide coverage to the UE by activating another beam or by adapting the current beam. When the UE approaches the cell edge area of the coverage area of the beam, a radio link quality would degrade and the UE would detect a beam failure based at least on a configured RSRP threshold. As the transition from in coverage to out of coverage may happen fast, the UE needs to monitor the radio link quality for beam failure detection early enough to be able to start using a new beam for transmissions and receptions.

Therefore, embodiments of the present disclosure further recognize that there is a need for a UE to determine when to start monitoring for beam failure detection.

Embodiments of the present disclosure further recognize that there is another need for a UE to determine a new beam for transmissions and receptions after a beam failure detection occurs.

Embodiments of the present disclosure further recognize that there is also another need to define procedures for beam failure recovery (BFR) that a UE would apply in order to change beam after beam failure detection occurs or after a condition is met. Assistance information provided by the UE to the satellite or serving gNB for the BFR mechanisms can include, but is not limited to, RSRP measurements based on SS/PBCH blocks or CSI-RSs receptions, or information associated with UE location, or information associated with UE-satellite/gNB distance information.

Throughout this disclosure, the term BFR is used to indicate a procedure including one or more steps for a UE to change a beam for transmissions and receptions to/from one or more satellite or serving gNB, or to/from one or more other UE.

In one embodiment, a BFR procedure at a UE can include some or each of the following steps: beam failure detection, new candidate beam identification, BFR request transmission and monitoring of the response from a serving node to the BFR request. The UE can be provided parameters via RRC signaling in RadioLinkMonitoringConfig, RadioLinkMonitoringRS, BeamFailureRecoveryConfig, PRACH-ResourceDedicatedBFR, BFR-SSB-Resource, or BFR-CSIRS-Resource, as described in [REF 6] for a TN, that are specific for the BFR procedure in NTN. For example, if the UE acquires SIB19 that includes NTN-specific parameters, the UE can be configured some or each of the NTN-specific BFR parameters herein.

For a BFR procedure, a UE monitors/receives SS/PBCH blocks or CSI-RSs, that are transmitted periodically by the satellite or the serving gNB using a first beam, to assess if a beam failure trigger condition has been met. The UE may also monitor SS/PBCH blocks or CSI-RSs, transmitted periodically by the satellite or the serving gNB, using a second beam or a set of second beams to identify one or more new candidate beams. In one example, a UE can detect a beam failure for the first beam if a number of consecutive detected beam failure instances exceeds a configured maximum number NBF within a time interval provided by beamFailure DetectionTimer, wherein the configured maximum number NBF and the time interval provided by beamFailureDetectionTimer are NTN-specific parameters. A beam failure instance can occur when a measured RSRP of SS/PBCH blocks or CSI-RSs using the first beam is below a threshold, or when a difference between measured RSRPs of SS/PBCH blocks or CSI-RSs using the first beam and the second beam is larger than a configured value. In another example, a beam failure can be detected on the first beam when NBF=1, that is when a measured RSRP of SS/PBCH blocks or CSI-RSs using the first beam is below a threshold, or when a difference between measured RSRPs of SS/PBCH blocks or CSI-RSs using the first beam and the second beam is larger than a configured value.

After detection of a beam failure, the UE initiates a random access procedure for beam recovery, and starts beamFailureRecoveryTimer, if configured. i) the UE selects contention free PRACH occasion and/or preamble corresponding to the new candidate beam and transmits the PRACH preamble. ii) the UE then starts the bfr-ResponseWindow at the start of the first PDCCH occasion after a fixed duration of a number of symbols from the end of the preamble transmission, wherein bfr-ResponseWindow is the RAR response window configured by the serving gNB for the BFR procedure. iii) the UE monitors PDCCH for detection of a DCI format with CRC scrambled with C-RNTI based on the new candidate beam for response to BFR request while bfr-ResponseWindow is running. iv) If the UE receives a PDCCH providing a DCI format with CRC scrambled with C-RNTI, the UE regards the BFR request procedure successfully completed and stops beamFailureRecoveryTimer. If bfr-ResponseWindow expires, the UE performs steps i), ii) and iii) again. If bfr-ResponseWindow expires and the UE has already transmitted PRACH for a configured number of times, the BFR request procedure is regarded unsuccessful and beamFailureRecoveryTimer stops. The UE then sends a request to the serving gNB to trigger a handover procedure. If beamFailureRecoveryTimer expires and BFR request procedure is not successfully completed, the UE stops using the contention free random access resources configured for BFR.

A first step of a BFR procedure at a UE (e.g., the UE 116) is beam failure detection by the UE and can be based on a rsrp-ThresholdBFR-ntn threshold provided via RRC signaling by the satellite or serving gNB. The satellite or serving gNB can configure a larger value for the rsrp-ThresholdBFR-ntn threshold when the satellite moves with a higher speed and configure a smaller value when the satellite moves with a lower speed for the UE to have enough time to change beam and have continuous coverage. The value of the rsrp-ThresholdBFR-ntn threshold may depend on a UE capability or a UE type or a type of traffic, with a higher threshold being configured for UEs with lower capabilities, or operating in reduced capability mode or power saving mode, needing more time to complete a beam change, or for traffic with higher QoS requirements. For example, the UE indicates the supported time period required to change a beam among candidate time period values set for beam change in NTN, and the satellite or serving gNB configures the value of the rsrp-ThresholdBFR-ntn threshold according to the UE supported capability. The candidate time period values can be associated with a frequency range and be different for FR1 or FR2 or FR3, or can be associated with a band or a band combination or a UE type or a UE operation in reduced capability mode or power saving mode.

The value of the rsrp-ThresholdBFR-ntn threshold may also depend on the location within the satellite footprint of the area with coverage provided by the current beam. For example, for the area C1 of FIG. 20 that is close to the satellite footprint edge and would be outside the satellite footprint as the satellite moves along its trajectory, the satellite or serving gNB may provide a value zero (with zero being the minimum value for an RSRP measurement) of the rsrp-ThresholdBFR-ntn threshold so that a BFR procedure is not initiated, and instead the satellite or serving gNB would initiate a handover procedure to a target satellite or target serving gNB. Alternatively, or additionally, the satellite or serving gNB may provide a new value of the rsrp-ThresholdBFR-ntn threshold while the UE is still in coverage with a first beam.

The UE may also be provided multiple thresholds. For example, a first threshold and a second threshold for beam failure detection, with the second threshold to be used in cell edge areas, or the first threshold to be used in a first area of the cell and the second threshold to be used in a second area of the cell. Whether to use the first threshold or the second threshold can be based on the UE location, or on the distance between the UE and the satellite or serving gNB, or on an indication by the satellite or serving gNB to the UE. For example, the satellite or serving gNB indicates via a MAC CE to start using the second threshold, wherein the second threshold is configured via RRC signaling or provided in the MAC CE triggering its use. Instead of being explicitly provided, the second threshold can be obtained after scaling the first threshold with a value that is configured via RRC signaling or provided by the MAC CE. When a handover procedure is triggered or when the UE, after receiving an indication by the satellite or serving gNB (e.g., the BS 102), starts monitoring and reporting a radio link quality using a configured RSRP threshold for handover, the UE is not expected to monitor/receive SSBs or CSI-RSs for beam failure using a rsrp-ThresholdBFR-ntn threshold.

The UE can apply the rsrp-ThresholdBFR-ntn threshold to assess a radio link quality when an RRC parameter BFR-NTN is configured, or when BFR-NTN is configured and set to enabled, or when BFR-NTN is switched from disabled to enabled. The UE assesses the radio link quality based on SS/PBCH blocks or CSI-RSs resource configurations provided by the satellite or the serving gNB. The UE may apply the same rsrp-ThresholdBFR-ntn threshold to RSRP measurements obtained for a SS/PBCH block or for a CSI-RS resource, or the UE may apply the rsrp-ThresholdBFR-ntn threshold to RSRP measurements obtained for a CSI-RS resource after scaling a respective CSI-RS reception power with a value provided by an RRC parameter powerOffset. For the UE to start monitoring for beam failure detection based on the rsrp-ThresholdBFR-ntn threshold, the satellite or the serving gNB may provide a dynamic indication via physical layer signalling or MAC CE. When the indication is provided by a field in a DCI format on a PDCCH or by a MAC CE in a PDSCH scheduled by a DCI format included in a PDCCH, the SS/PBCH blocks or CSI-RSs used for RSRP measurements can be quasi co-located with the DM-RS of the PDCCH receptions.

When a UE is located in a first cell area, for example cell area C1 of FIG. 20, and coverage in the first area is provided by a satellite or a serving gNB through a first beam and a timing advance command is received on uplink slot n, the corresponding adjustment of the uplink transmission timing applies from the beginning of uplink slot n+k+1+2^{μ}·K_{offset} where

$$k = ⌈ {N}_{slot}^{subframe , μ} \cdot ( {N}_{T , 1} + {N}_{T , 2} + {N}_{TA , max} + 0 \text{.5} ) / {T}_{sf} ⌉ ,$$

N_{T,1} is a time duration in msex of N₁ symbols corresponding to a PDSCH processing time for UE processing capability 1 when additional PDSCH DM-RS is configured, as defined in [REF 4], N_{T,2} is a time duration in msec of N₂ symbols corresponding to a PUSCH preparation time for UE processing capability 1, N_{TA,max} is the maximum timing advance value in msec that can be provided by a TA command field, for example of 12 bits,

$${N}_{slot}^{subframe , μ}$$

is the number of slots per subframe, T_{sf} is the subframe duration, for example of 1 msec, and K_{offset}=K_{cell-beam,offset}−K_{UE,offset}, where K_{cell-beam}, offset is provided by cell-beamSpecificKoffset and KUE, offset is provided by a differential koffset MAC CE command. K_{cell-beam,offset} and K_{UE,offset} are beam-specific and are associated with the beam used for the uplink transmission.

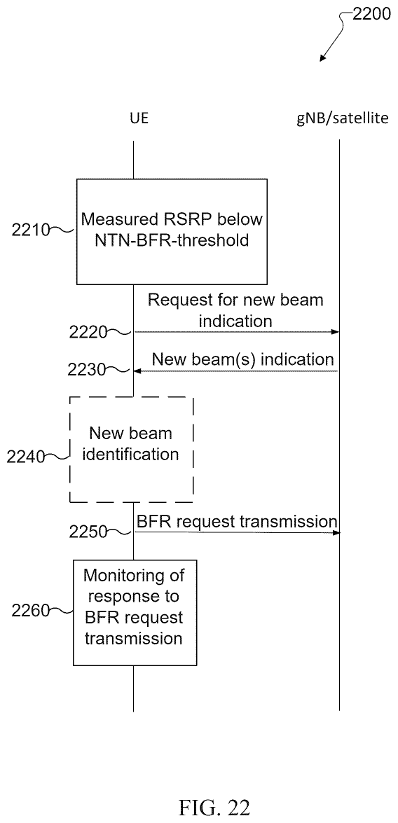

FIG. 22 illustrates a flowchart of an example procedure 2200 for BFR according to embodiments of the present disclosure. For example, procedure 2200 can be performed by the UE 116 and the satellite 2110 of FIG. 21, and/or gNB 102 of FIG. 1, and/or network 130 in the wireless network 100 of FIG. 1. This example is for illustration only and other embodiments can be used without departing from the scope of the present disclosure.

The procedure begins in 2210, where a UE measures RSRP below a NTN-BFR threshold. In 2220, the UE transmits a request for a new beam indication to BS/gNB 102 and/or the satellite 2110. In 2230, the BS/gNB 102 and/or the satellite 2110 transmits a new beam(s) indication to the UE. In 2240, the UE may identify the new beam(s). In 2250, the UE transmits a BFR request to the BS/gNB 102 and/or the satellite 2110. In 2260, the UE monitors for a response to the transmitted BFR request.

In a first approach, a UE periodically monitors a radio link quality based on receptions of SS/PBCH blocks or CSI-RSs resource configurations indicated by a satellite or serving gNB. The UE determines RSRP measurements based on SS/PBCH blocks or CSI-RSs that are transmitted periodically by the satellite or the serving gNB using a current beam. When a measured RSRP based on receptions of SS/PBCH blocks or CSI-RSs is below a threshold, for example below rsrp-ThresholdBFR-ntn threshold, if provided, the UE sends a request to the satellite or the serving gNB in order for the UE to be provided a beam indication and to start a BFR procedure using the indicated beam as a candidate beam. The UE sends the request after determining that a number of consecutive beam failure instances exceeds a configured maximum number N_{BF} within a time interval provided by a higher layer parameter, wherein the configured maximum number N_{BF} and the time interval are NTN-specific higher layer parameters.

For the request to the satellite or the serving gNB for beam indication, the UE can be provided a configuration for PRACH transmission with dedicated PRACH resources, or a configuration for dedicated PUCCH resources, or a configuration for SRS. The UE would then transmit a PRACH, or a PUCCH, or an SRS in corresponding dedicated resources for beam indication request using the current beam. The request for beam indication can also include a report of a measured RSRP by the UE, for example when the request is provided by a PUCCH. For example, when the measured RSRP based on receptions of SS/PBCH blocks or CSI-RSs is below the rsrp-ThresholdBFR-ntn threshold, the UE reports the measured RSRP or the difference between the measured RSRP and the rsrp-ThresholdBFR-ntn threshold, and after a time interval from the last uplink slot or symbol used for transmission of the report, the UE starts monitoring for PDCCH reception in response to the report using the current beam. The report can be also provided by the UE in a MAC CE.

The satellite or the serving gNB may indicate one or multiple beams by higher layers in a PDSCH scheduled by a PDCCH. If the indication is for multiple beams, the UE may identify a beam from the multiple beams and use the identified beam for a PRACH, or PUCCH, or SRS, or PUSCH transmission. For example, when the UE is provided two indexes qnew,1 and qnew,2 associated with SS/PBCH blocks or CSI-RS resources, the UE selects the index associated with the largest RSRP measurement and transmits a PRACH or an SRS using a spatial setting associated with the selected beam index. After a time interval from the last uplink slot or symbol used for the PRACH or SRS transmission, the UE starts monitoring for PDCCH reception in response to the PRACH or SRS transmission using the spatial setting associated with the selected beam index. Alternatively, the UE transmits a PUCCH to indicate the selected beam to the gNB using the current beam, and after a time interval from the last uplink slot or symbol used for the PUCCH transmission, the UE starts monitoring for PDCCH reception in response to the PUCCH using the spatial setting associated with the selected beam index.

In one example, the UE is provided by higher layers an index qnew associated with periodic CSI-RS resource configuration or with a SS/PBCH block. The UE is provided a configuration for PRACH transmission with dedicated PRACH resources for BFR procedure. For PRACH transmission in slot n and according to antenna port quasi co-location parameters associated with periodic CSI-RS resource configuration, or with an SS/PBCH block, associated with index qnew provided by higher layers, the UE monitors PDCCH in a search space set configured for the BFR procedure for detection of a DCI format with CRC scrambled by C-RNTI starting from slot n+4+2^{μ}·k_{mac}, where μ is the SCS configuration for the PRACH transmission and k_{mac} is a number of slots provided by kmac, within a window configured by higher layers for the BFR procedure. The kmac parameter is beam-specific and, for an uplink transmission with a spatial setting associated with index q_{new}, the value of kmac is configured for index q_{new}. For PDCCH monitoring and for corresponding PDSCH receptions, the UE expects the same antenna port quasi-collocation parameters as the ones associated with index q_{new} until the UE receives by higher layers an activation for a TCI state. After the UE detects a DCI format with CRC scrambled by C-RNTI in the search space set configured for the BFR procedure, the UE continues to monitor PDCCH candidates in the search space set configured for the BFR procedure until the UE receives a MAC CE activation command for a TCI state.

In one example, the UE is provided by higher layers an index q_{new} associated with a periodic CSI-RS resource configuration or with an SS/PBCH block. The UE is provided a configuration for PUCCH transmission for BFR procedure. The UE sends the request for BFR by a PUCCH. For PUCCH transmission in slot n and according to antenna port quasi co-location parameters associated with the periodic CSI-RS resource configuration or with the SS/PBCH block associated with index q_{new} provided by higher layers, the UE monitors PDCCH in a search space set configured for the BFR procedure for detection of a DCI format with CRC scrambled by C-RNTI starting from slot n+4+2^{μ}·k_{mac}, where μ is the SCS configuration for the PUCCH transmission and k_{mac} is a number of slots provided by k_{mac} within a window configured by higher layers for the BFR procedure. The k_{mac} parameter is beam-specific, and for an uplink transmission with a spatial setting associated with index q_{new}, the value of kmac is configured for index q_{new}. For PDCCH monitoring and for corresponding PDSCH receptions, the UE expects the same antenna port quasi-collocation parameters as the ones associated with index q_{new} until the UE receives by higher layers an activation for a TCI state. After the UE detects a DCI format with CRC scrambled by C-RNTI in the search space set configured for the BFR procedure, the UE continues to monitor PDCCH candidates in the search space set configured for the BFR procedure until the UE receives a MAC CE activation command for a TCI state.

With reference to FIG. 22, an example BFR procedure is shown according to the descriptions herein. When the UE is provided information for one beam, the UE uses a spatial setting associated with the one beam for the BFR request transmission. When the UE is provided information for multiple beams, the UE identifies a first beam from the multiple beams and uses a spatial setting associated with the identified beam for the BFR request transmission. If the BFR procedure with the identified beam is not successful, the UE may identify a second beam from the multiple beams and use a second spatial setting associated with the second beam for the BFR request transmission, or send a new request for beam information.

In response to a BFR request transmission of a PRACH, the UE starts a bfr-ResponseWindow at the start of the first PDCCH occasion after a time interval of a number of symbols or slots from the end of the PRACH transmission, wherein the bfr-Response Window is the RAR response window configured by the satellite or the serving gNB for the BFR procedure. The UE monitors PDCCH for detection of a DCI format with CRC scrambled with C-RNTI in response to the BFR request transmission while the bfr-Response Window is running. PRACH resources can be configured for contention free or contention based random access procedure and when the UE receives a PDCCH providing a DCI format with CRC scrambled with C-RNTI, the UE regards the BFR request procedure successfully completed and transmits an initial PUSCH or PUCCH or SRS using a same spatial setting as for the last PRACH transmission until the UE receives other spatial relation information for UL transmissions by RRC signaling, or receives an activation command for an RRC parameter that includes spatial relation information. For example, for a PUCCH transmission after reception of a PDCCH providing a DCI format with CRC scrambled with C-RNTI, the UE transmits the PUCCH using a same spatial setting as for the last PRACH transmission until the UE receives an activation command for PUCCH-SpatialRelationInfo or PUCCH-SpatialRelationInfo for PUCCH resource(s).

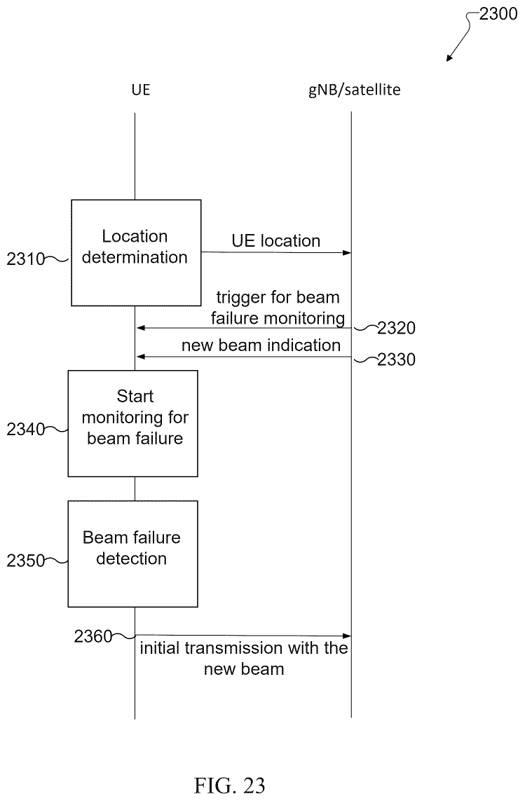

FIG. 23 illustrates a flowchart of an example procedure 2300 for BFR according to embodiments of the present disclosure. For example, procedure 2300 can be performed by the UE 116 and the satellite 2110 of FIG. 21, and/or gNB 102 of FIG. 1, and/or network 130 in the wireless network 100 of FIG. 1. This example is for illustration only and other embodiments can be used without departing from the scope of the present disclosure.

The procedure begins in 2310, a UE determines the UE's (its own) location and transmits the UE's location to a BS/gNB 102 and/or the satellite 2110. In 2320, the BS/gNB 102 and/or the satellite 2110 transmits a trigger for beam failure monitoring to the UE. In 2330, the BS/gNB 102 and/or the satellite 2110 transmits a new beam(s) indication to the UE. In 2340, the UE starts monitoring receptions for beam failure. In 2350, the UE detects beam failure. In 2360, the UE transmits an initial transmission with the new beam to the BS 102 and/or the satellite 2110.

In a second approach, the UE starts monitoring receptions for beam failure detection using the rsrp-ThresholdBFR-ntn threshold based on a mechanism that uses the UE location.

In one example, the UE determines periodically the UE location, and based on UE location and satellite ephemeris that the UE periodically acquires or aperiodically requests, the UE autonomously starts monitoring a radio link quality using the rsrp-ThresholdBFR-ntn threshold after verifying a condition associated with the UE location. For example, the condition can be that the UE is located within an area, and information of the area are (pre-) configured to the UE, or broadcasted periodically by the satellite or the serving gNB or acquired from the satellite or the serving gNB after a UE request. When a measured RSRP based on receptions of SS/PBCH blocks or CSI-RSs is below the rsrp-ThresholdBFR-ntn threshold the UE may send a request to the satellite to be provided a beam indication.

In one example, the UE determines periodically the UE location, provides the UE location to the satellite or the serving gNB, and monitors for reception of an indication to start monitoring for beam failure detection using the rsrp-ThresholdBFR-ntn threshold and/or for reception of a beam indication that the UE would use for beam failure recovery.

The UE can provide the UE location periodically, or after receiving a request from the satellite or the serving gNB in a DCI format or in a MAC CE. The indication from the satellite or the serving gNB for the UE to start monitoring for beam failure detection can be provided by a field in a DCI format on a PDCCH, wherein a value “0” of the field, or a value “1” of the field, indicates to start the monitoring CSI-RS or SSB receptions for beam failure detection, or by a PDSCH scheduled by a DCI format included in a PDCCH. The UE can also provide UE location after verifying a condition associated with the UE location. For example, the condition can be that the UE is located within an area, and information of the area is (pre-) configured to the UE, or broadcasted periodically by the satellite or serving gNB or acquired from the satellite or serving gNB after a UE request.

The beam indication can be an SS/PBCH block index or a CSI-RS resource index. The UE would monitor/receive SS/PBCH blocks or CSI-RSs transmitted periodically by the satellite or the serving gNB using a current beam to assess if the beam failure trigger condition has been met and, if met, the UE transmits a channel or signal with a spatial setting associated with the new beam. The transmission can be of a PRACH or PUSCH or PUCCH or SRS.

When the transmission is for a BFR request, the UE transmits a PRACH and, in response, starts a bfr-Response Window at the start of the first PDCCH occasion after a fixed duration of a number of symbols from the end of the PRACH preamble transmission, wherein the bfr-Response Window is the RAR response window configured by the satellite or the serving gNB for the BFR procedure. The UE monitors PDCCH for detection of a DCI format with CRC scrambled with C-RNTI for response to the BFR request transmission while the bfr-ResponseWindow is running. If the bfr-ResponseWindow expires and the UE has not received a PDCCH providing a DCI format with CRC scrambled with C-RNTI, whether the UE transmits again a PRACH and in response monitors for PDCCH receptions or regards the BFR request procedure unsuccessful and stops beamFailureRecoveryTimer, can be subject to a configuration by the satellite or the serving gNB.

With reference to FIG. 23, an example of BFR procedure according to the descriptions herein is shown when the UE receives an indication to start monitoring for beam failure detection using the rsrp-ThresholdBFR-ntn threshold and an indication of a new beam that the UE would use for BFR.

In an alternative to the BFR procedure illustrated in FIG. 23, the UE can perform a beam change procedure from a first beam that is a current beam to a second beam that is a new beam provided by the satellite or the serving gNB. When the UE receives information for the second beam, the UE transmits a PRACH using a spatial setting associated with the second beam and starts a Response Window at the start of the first PDCCH occasion after a fixed duration of a number of symbols from the end of the PRACH preamble transmission, wherein the Response Window is the RAR response window configured by the satellite or the serving gNB for the beam change procedure. The UE monitors PDCCH for detection of a DCI format with CRC scrambled with C-RNTI in response to the PRACH transmission while the Response Window is running. If the Response Window expires and the UE has not detected a PDCCH providing a DCI format with CRC scrambled with C-RNTI, the UE sends a request to the satellite or the serving gNB to trigger a handover procedure. The UE sends the request by transmitting a PRACH with a spatial setting associated with the first beam.

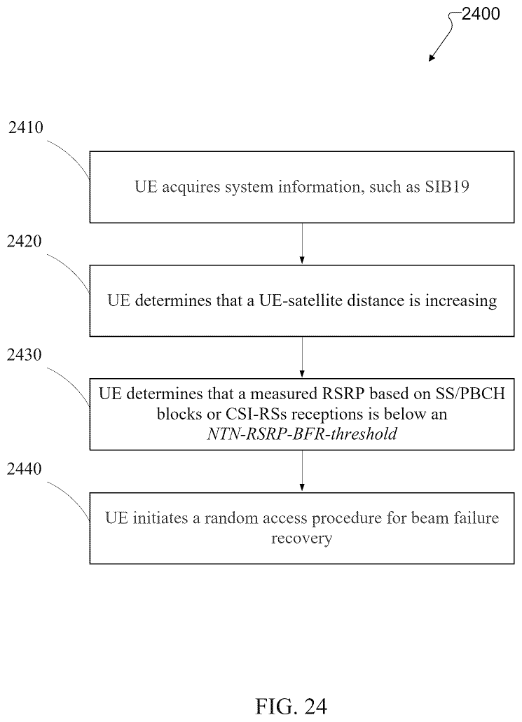

FIG. 24 illustrates a flowchart of an example UE procedure 2400 for BFR according to embodiments of the present disclosure. For example, procedure 2400 can be performed by any of the UEs 111-116 of FIG. 1, such as the UE 114. This example is for illustration only and other embodiments can be used without departing from the scope of the present disclosure.

A UE acquires system information, such as SIB19, that provides parameters such as ephemeris data, common timing advance parameters, koffset, validity duration for UL synchronization epoch time 2410, for example as described in [REF 3], [REF 5], and [REF 6]. Based on the parameters, the UE determines that a UE-satellite distance is increasing 2420. The UE determines that a measured RSRP based on SS/PBCH blocks or CSI-RSs receptions is below an NTN-RSRP-BFR-threshold 2430. The UE initiates a random access procedure for beam failure recovery 2440.

In a third approach, the UE starts monitoring/receiving SS/PBCH blocks or CSI-RSs for beam failure detection using the rsrp-ThresholdBFR-ntn threshold based on a distance between the UE and the satellite or serving gNB.

With reference to FIG. 24, an example procedure is shown for a BFR procedure in NTN based on a UE-satellite distance information according to the disclosure.

In one example, the UE determines a first value and a second value of a distance from the satellite or the serving gNB in a first time instance and in a second time instance respectively, wherein the second time instance is later than the first time instance. If the second value is larger than the first value, or is larger than the first value by a configured delta value, the UE starts monitoring for beam failure detection using the rsrp-ThresholdBFR-ntn threshold or sends a request to the satellite or the serving gNB to be provided a beam indication. The first time instance can be the time when the UE is at a minimum distance from the satellite or the serving gNB, and the UE may start monitoring for beam failure detection using the rsrp-ThresholdBFR-ntn threshold, or send a request to the satellite or the serving gNB to be provided a beam indication, when the UE is at minimum distance from the satellite, that is when the first and second values are same or, equivalently, the delta value is zero.

In one example, the UE receives an indication from the satellite or the serving gNB when the UE is at minimum distance from the satellite or the serving gNB. The indication of minimum distance from the satellite or the serving gNB may trigger the UE to monitor/receive SS/PBCH blocks or CSI-RSs for beam failure detection using the rsrp-ThresholdBFR-ntn threshold. The UE may start the process for beam failure detection after a configured time period from the reception of the indication of minimum distance from the satellite or the serving gNB. After receiving the indication of minimum distance from the satellite or the serving gNB, the UE can also receive a new beam information for the UE to use for beam failure recovery wherein, for example, the new beam information can be indicated by higher layer signaling, such as via a MAC CE or RRC.

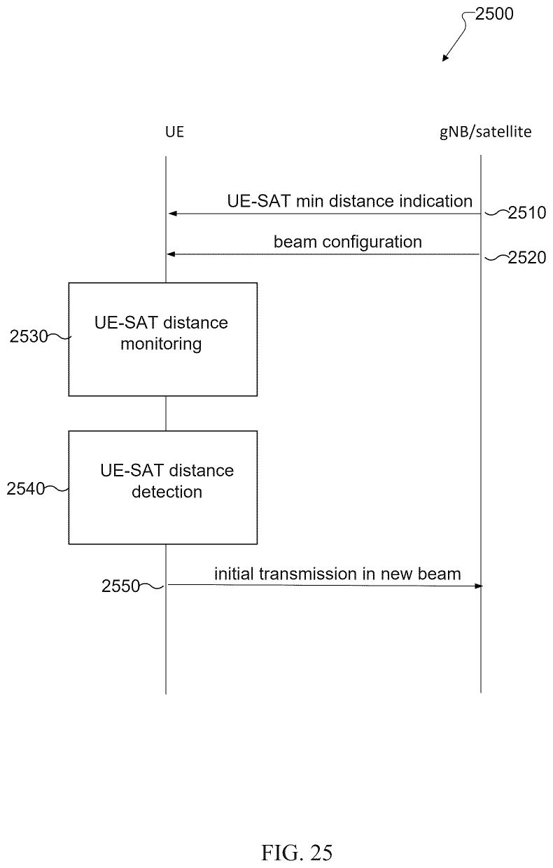

FIG. 25 illustrates a flowchart of an example procedure 2500 for a beam change according to embodiments of the present disclosure. For example, procedure 2500 can be performed by the UE 116 and the satellite 2110 of FIG. 21, and/or gNB 102 of FIG. 1, and/or network 130 in the wireless network 100 of FIG. 1. This example is for illustration only and other embodiments can be used without departing from the scope of the present disclosure.

The procedure begins in 2510, a BS/gNB 102 and/or the satellite 2110 transmits a UE-SAT minimum distance indication to a UE. In 2520, the BS/gNB 102 and/or the satellite 2110 transmits a beam configuration to the UE. In 2530, the UE monitors a UE-SAT distance. In 2540, the UE detects the UE-SAT distance. In 2550, the UE transmits an initial transmission in a new beam to the BS 102 and/or the satellite 2110.

With reference to FIG. 25, an example procedure is shown for a beam change based on a UE-satellite distance according to the disclosure. The UE receives an indication of being at minimum distance from the satellite or the serving gNB and information for a new beam. Then the UE monitors the UE-satellite distance and, when a condition is met, the UE transmits a channel or signal using a spatial setting associated with the new beam, wherein the condition can be that the UE-satellite distance is larger than a configured value, and the transmission can be of a PRACH or a PUSCH or a PUCCH or an SRS.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user-equipment (UE) to perform a beam failure recovery (BFR) procedure on a first cell, the method comprising:
receiving first information for a set of power values for a synchronization signal and primary broadcast channel (SS/PBCH) block on the first cell;
receiving second information for a set of reference signal received power (RSRP) threshold values associated with the SS/PBCH block on the first cell;
receiving third information for a mapping between the set of power values and the set of RSRP threshold values;
receiving fourth information indicating a first power value from the set of power values;
receiving the SS/PBCH block on the first cell;
determining an RSRP threshold value, based on the third information and the first power value;
determining an RSRP value based on the SS/PBCH block on the first cell; and
determining to perform a beam failure recovery (BFR) procedure on the first cell when the RSRP value is smaller than the RSRP threshold value.

2. The method of claim 1, further comprising:
receiving fifth information for a first RSRP threshold value via a system information block, and
receiving sixth information for a second RSRP threshold value via UE-dedicated radio resource control signaling,
wherein determining the RSRP threshold value comprises determining the RSRP threshold value as a sum of the first RSRP threshold value and the second RSRP threshold value.

3. The method of claim 1, wherein the fourth information is provided by a downlink control information (DCI) format or by a medium access control (MAC) control element (CE).

4. The method of claim 1, further comprising:
receiving fifth information indicating a second cell, and
receiving the SS/PBCH block on the second cell when the first power value is zero.

5. The method of claim 4, further comprising:
receiving sixth information indicating a location in frequency of the SS/PBCH block on the second cell.

6. The method of claim 1, further comprising:
receiving fifth information indicating a second cell; and
transmitting a physical random access channel (PRACH) on the second cell when the first power value is zero.

7. The method of claim 1, further comprising:
determining a power class based on the first power value,
determining a power for transmission of a channel or signal based on the power class; and
transmitting the channel or signal using the power.

8. A user equipment (UE) comprising:
a transceiver configured to:
receive first information for a set of power values for a synchronization signal and primary broadcast channel (SS/PBCH) block on a first cell,
receive second information for a set of reference signal received power (RSRP) threshold values associated with the SS/PBCH block on the first cell,
receive third information for a mapping between the set of power values and the set of RSRP threshold values,
receive fourth information indicating a first power value from the set of power values, and
receive the SS/PBCH block on the first cell; and
a processor operably coupled to the transceiver, the processor configured to:
determine an RSRP threshold value, based on the third information and the first power value,
determine an RSRP value based on the SS/PBCH block on the first cell, and
determine to perform a beam failure recovery (BFR) procedure on the first cell when the RSRP value is smaller than the RSRP threshold value.

9. The UE of claim 8, wherein:
the transceiver is further configured to:
receive fifth information for a first RSRP threshold value via a system information block, and
receive sixth information for a second RSRP threshold value via UE-dedicated radio resource control signaling; and
the processor is further configured to determine the RSRP threshold value as a sum of the first RSRP threshold value and the second RSRP threshold value.

10. The UE of claim 8, wherein the fourth information is provided by a downlink control information (DCI) format or by a medium access control (MAC) control element (CE).

11. The UE of claim 8, wherein the transceiver is further configured to:
receive fifth information indicating a second cell, and
receive the SS/PBCH block on the second cell when the first power value is zero.

12. The UE of claim 11, wherein the transceiver is further configured to receive sixth information indicating a location in frequency of the SS/PBCH block on the second cell.

13. The UE of claim 8, wherein the transceiver is further configured to:
receive fifth information indicating a second cell; and
transmit a physical random access channel (PRACH) on the second cell when the first power value is zero.

14. The UE of claim 8, wherein:
the processor is further configured to:
determine a power class based on the power value, and
determine a power for transmission of a channel or signal based on the power class; and
the transceiver is further configured to transmit the channel or signal using the power.

15. A base station comprising:
a processor; and
a transceiver operably coupled to the transceiver, the transceiver configured to:
transmit first information for set of power values for a synchronization signal and primary broadcast channel (SS/PBCH) block on a first cell,
transmit second information for a set of reference signal received power (RSRP) threshold values associated with the SS/PBCH block on the first cell,
transmit third information for a mapping between the set of power values and the set of RSRP threshold values,
transmit fourth information indicating a first power value from the set of power values, and
transmit the SS/PBCH block on the first cell.

16. The base station of claim 15, wherein:
the transceiver is further configured to:
transmit fifth information for a first RSRP threshold value via a system information block, and
transmit sixth information for a second RSRP threshold value via radio resource control signaling dedicated to a user equipment, and
the RSRP threshold value is a sum of the first RSRP threshold value and the second RSRP threshold value.

17. The base station of claim 15, wherein the fourth information is provided by a downlink control information (DCI) format or by a medium access control (MAC) control element (CE).

18. The base station of claim 15, wherein the transceiver is further configured to:
transmit fifth information indicating a second cell, and
transmit the SS/PBCH block on the second cell when the first power value is zero.

19. The base station of claim 15, wherein the transceiver is further configured to transmit sixth information indicating a location in frequency of the SS/PBCH block on the second cell.

20. The base station of claim 15, wherein the transceiver is further configured to:
transmit fifth information indicating a second cell; and
receive a physical random access channel (PRACH) on the second cell when the first power value is zero.
